(19) United States
(12) Patent Application Publication
(10) Pub. No.: US 2016/0098653 A1
(43) Pub. Date: Apr. 7, 2016

(54) Risk Analysis to Improve Operational Workforce Planning

(71) Applicants: Soren Hojby, Dyssegard (DK); Kit Yue Zhang, Sterling, VA (US)

(72) Inventors: Soren Hojby, Dyssegard (DK); Kit Yue Zhang, Sterling, VA (US)

(21) Appl. No.: 14/506,446

(22) Filed: Oct. 3, 2014

(51) Int. Cl. G06Q 10/06

(52) U.S. Cl. CPC G06Q 10/0635; G06Q 10/06393

(57) ABSTRACT

Techniques are described for operational workforce planning tool. The planning tool can be utilized by a manager to analyze an existing workforce plan. A manager within the organization can adjust the workforce plan based on planning criteria. The adjustments can be stored as planning tasks of the workforce plan. Changes made to the workforce by a lower level manager can be rolled up to an upper level manager for review and approval before the changes are finalized. Furthermore, upper level managers can generate sub-plans for lower level managers. Sub-plans can include planning criteria that is created by an upper level manager for a lower level manager. The lower level managers can report back to the upper level manager on the completion of the sub-plan when the lower level manager rolls up his changes to the workforce plan for the manager to review.

### BACKGROUND

A typical organization includes thousands of employees. An employee with subordinates is traditionally called a manager since the employee manages others while an employee who reports to a manager is traditionally called a direct report. Some employees within the organization can be both a manager and a subordinate since the manager directly reports to another manager. Each manager can be responsible for a team of direct reports. As a result, the organization can consist of a nested groups of teams where an upper level managers manage lower level managers, whom each manage a team of employees. As organizations grow, the needs of the organization can dynamically change. For example, a first business sector may experience increased revenue while another sector is experiencing a decline in revenue. Workforce planning tools are needed to better optimize the composition of the workforce to meet those needs.

### SUMMARY

In one embodiment, a computer-implemented method receives, by a processor, a plurality of attributes that belong to a team member, the team member being part of a team within an organization. The method then orders, by the processor, the plurality of attributes into an ordered list of attributes. The method then identifies, by the processor, a first set of employees having the ordered list of attributes that are currently employed by the organization. The method then identifies, by the processor, a second set of employees having the ordered list of attributes that have voluntarily left the organization. The method then calculates, by the processor, a predicted voluntary termination rate for the team member based on the first set of employees and the second set of employees.

In another embodiment, a non-transitory computer readable storage medium stores one or more programs comprising instructions for receiving a plurality of attributes that belong to a team member, the team member being part of a team within an organization, ordering the plurality of attributes into an ordered list of attributes, identifying a first set of employees having the ordered list of attributes that are currently employed by the organization, identifying a second set of employees having the ordered list of attributes that have voluntarily left the organization, and calculating a predicted voluntary termination rate for the team member based on the first set of employees and the second set of employees.

In another embodiment, a computer implemented system comprises one or more computer processors and a non-transitory computer-readable storage medium. The non-transitory computer-readable storage medium comprises instructions, that when executed, receive a plurality of attributes that belong to a team member, the team member being part of a team within an organization, order the plurality of attributes into an ordered list of attributes, identify a first set of employees having the ordered list of attributes that are currently employed by the organization, identify a second set of employees having the ordered list of attributes that have voluntarily left the organization, and calculate a predicted voluntary termination rate for the team member based on the first set of employees and the second set of employees.

The following detailed description and accompanying drawings provide a better understanding of the nature and advantages of the present disclosure.

### BRIEF DESCRIPTION OF THE DRAWINGS

FIG. 1 illustrates a system according to one embodiment;

FIG. 2 illustrates a workforce plan according to one embodiment;

FIG. 3 illustrates a system for generating a manager view according to one embodiment;

FIG. 4 illustrates an example of a manager view according to one embodiment;

FIG. 5 illustrates a system for updating a manager view according to one embodiment;

FIG. 6 illustrates an updated manager view according to one embodiment;

FIG. 7 illustrates a planning process according to one embodiment;

FIG. 8 illustrates an upper level manager view according to one embodiment;

FIG. 9 illustrates a lower level manager view according to one embodiment;

FIG. 10 illustrates another upper level manager view according to one embodiment;

FIG. 11 illustrates a manager view according to one embodiment;

FIG. 12 illustrates another manager view according to one embodiment;

FIG. 13 illustrates a window containing an organizational chart according to one embodiment;

FIG. 14 illustrates a system for recommending transfers according to one embodiment;

FIG. 15 illustrates a system for analyzing risk according to one embodiment;

FIG. 16 illustrates a process for generating a manager view according to one embodiment;

FIG. 17 illustrates a process for cascading a sub-plan for an upper level manager to a lower level manager according to one embodiment;

FIG. 18 illustrates a process for transferring employees between managers according to one embodiment;

FIG. 19 illustrates a process for transferring employees between managers according to one embodiment; and

FIG. 20 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

An operational workforce planning tool is described herein. The planning tool can be utilized by a manager to analyze an existing workforce plan. The workforce plan can describe the organizational layout of an organization. For example, the workforce plan can define the groups/teams within the organization and the hierarchy of the organization. The workforce planning tool can also adjust an existing workforce plan for the purpose of achieving one or more objectives. Managers can create planning tasks that define one or more changes to the workforce plan. The changes can include adding/removing positions within a team, hiring a new employee for a team, transferring employees between teams, promoting employees within a team, and providing rationale for the changes.

In some embodiments, the manager can create planning tasks according to a set of planning criteria that is provided from strategic workforce planning. Strategic workforce planning is traditionally performed by upper level management whose focus is on providing guidance for future business development. Strategic workforce planning can result in planning criteria such as critical roles, company goals, team goals, product development, risk mitigation, headcount budget, and workforce budget. A manager within the organization can adjust the workforce plan based on these planning criteria (e.g., objectives). The adjustments can be stored as planning tasks of the workforce plan. Planning tasks created by a manager can be passed to upper level management for approval. Once approved, the human resources department can execute the approved planning tasks and thus alter the workforce plan. In some embodiments, lower level manager changes to the workforce plan can be rolled up to an upper level manager for review and approval before the changes are finalized and committed by human resources. In some embodiments, upper level managers can generate sub-plans for lower level managers. Sub-plans can include planning criteria created by an upper level manager and assigned to a lower level manager. This allows an upper level manager to offload some or all of a planning criteria belonging to an upper level manager to one or more lower level managers. The lower level managers can report back to the manager on the completion of the sub-plan when the lower level manager rolls up his changes to the workforce plan for the manager to review.

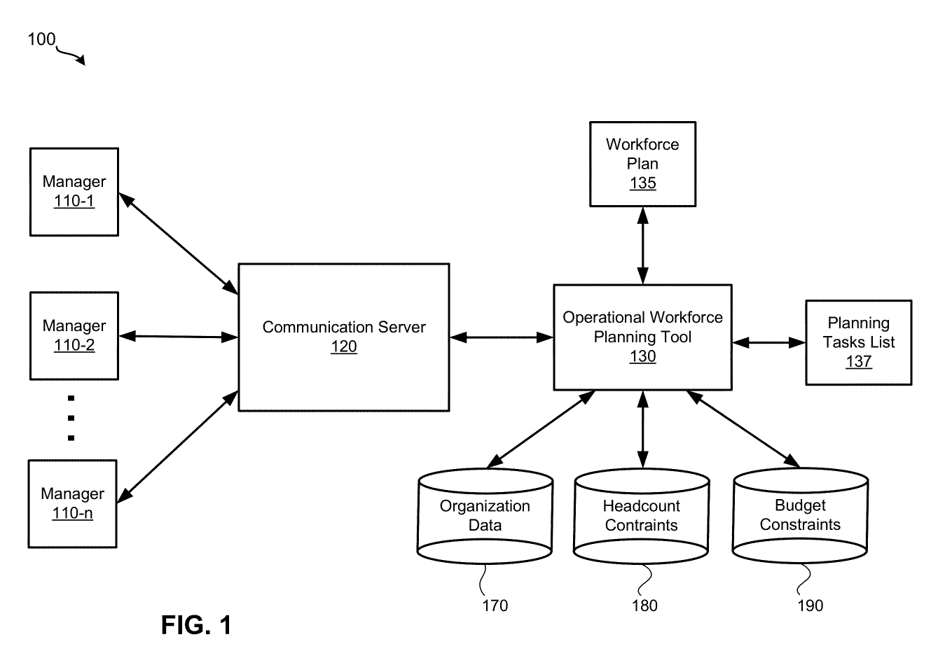

FIG. 1 illustrates a system according to one embodiment. System 100 includes managers 110-1 to 110-n, communication server 120, and operational workforce planning tool 130. Operational workforce planning tool 130 is a software application running on a processor. The software application is configured to generate a manager view. The manager view is a view of workforce plan 130 from the perspective of a particular manager. As a result, the manager view can present information from workforce plan 130 that is relevant to the manager while leaving out information that may be irrelevant to the manager. Operational workforce planning tool 130 can generate the manager view from data retrieved from organization data 170, headcount constraints 180, and budget constraints 190. Organization data 170 can include data that describes the organization. This can include data on employees within the organization (e.g., compensation history, employment history, skills, roles, etc.) and also data on the organization (e.g., organizational hierarchy, groups within the organization, etc.). Headcount constraints 180 can include constraints on the headcount for teams or groups within the organization. Budget constrains 190 can include constraints on the budget for teams or groups within the organization. Headcount constraints 180 and budget constraints 190 can be set by upper level management. Once the manager view is generated, operational workforce planning tool 130 can transmit the manager view to the corresponding manager through communication server 120. A client device operated by the manager can receive the manager view from communication server 120 and present the manager view to the manager.

Manager 110-1 can review a manager view on a client device and decide to modify a one of the manager's team presented in the manager view. The team can be a team which manager 110-1 directly or indirectly manages. To modify a team, manager 110-1 can submit a planning task to operational workforce planning tool 130. The planning task can be transmitted from a client device operated by manager 110-1 to operational workforce planning tool 130 via communication server 120. The planning task can define a proposed change to the workforce plan. The change can be adding/removing positions within a team, hiring a new employee for a team, transferring employees between teams, and promoting employees within a team. Rationale for the change can also be provided in the planning task.

In one embodiment, operational workforce planning tool 130 can process the planning task to update workforce plan 135. In another embodiment, operational workforce planning tool 130 can seek approval of the planning task before processing the planning task to update workforce plan 135. The planning task can have a state and a list of approvers. The state describes the status of the planning task and can be set to submitted or committed. A planning task having a submitted state indicates that the planning task was submitted by a manager (but has yet to be executed since approval may not have been granted yet) while a planning task having a committed state indicates that the planning task has not only been submitted, but has also been committed as part of workforce plan 135 (i.e., the planning task has been processed and is now part of workforce plan 135). The list of approvers can identify the employees who are to approve the planning task before the state of the planning task can change from submitted to committed. A planning task which has been received from manager 110-1 can initially be stored in a submitted state within planning tasks list 137. Once the list of approvers have approved the planning task, the status of the planning task can be changed to committed. Operational workforce planning tool 130 can process committed planning tasks to update workforce plan 135. In one example, committed planning tasks can be stored in planning tasks 137 as a record of the changes to workforce plan 135. In another example, committed planning tasks can be deleted from planning tasks list 137 to reduce the memory of planning tasks list 137. The committed planning tasks can alternatively be stored elsewhere as a history of the changes to workforce plan 135.

In one embodiment, planning tasks that are in a submitted state can be presented as part of a manager view. This allows managers to be presented with a manager view that resembles what the teams associated with the manager would appear like if the planning tasks are committed into workforce plan 135. The changes proposed by the planning tasks can be presented with visual modifiers to indicate that the changes have been submitted but have not been committed. For example, a new addition to a team can be presented inside a box with a bold line border while a departing member of the team can be presented inside a box with a dashed line border.

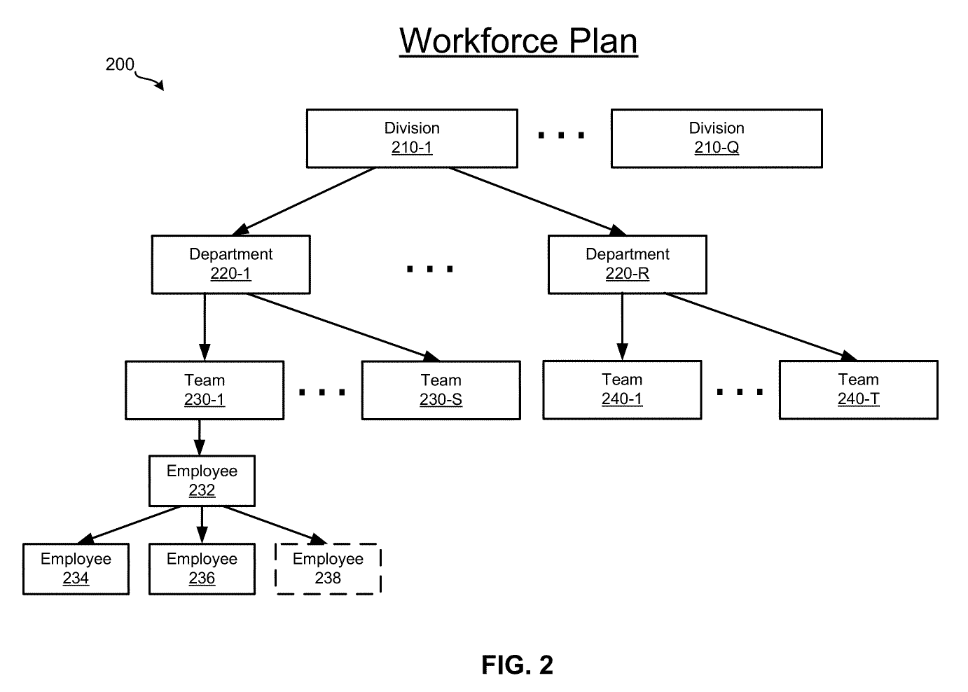

FIG. 2 illustrates a workforce plan according to one embodiment. Workforce plan 200 can define the layout of the organization. As shown, workforce plan 200 includes divisions 210-1 to 210-Q. Each division can represent a division within a company. For example, division 210-1 can be the technology division. Division 210-1 can include departments 220-1 to 220-R. Each department can represent a department within division 210-1. For example, department 220-1 can be the engineering department while department 220-R can be the QA department. Department 220-1 can include teams 230-1 to 230-S. Each team can represent a team within department 220-1. For example, team 230-1 can be the database team while team 230-S can be the user interface development team. Each division, department, or team can include one or more employees. Some employees may be managers while other employees can be direct reports. Here, team 230-1 includes employee 232 who manages employees 234, 236, and 238. As shown here, employee 238 is presented as a dotted line box since a planning task has been submitted to remove or reassign employee 238.

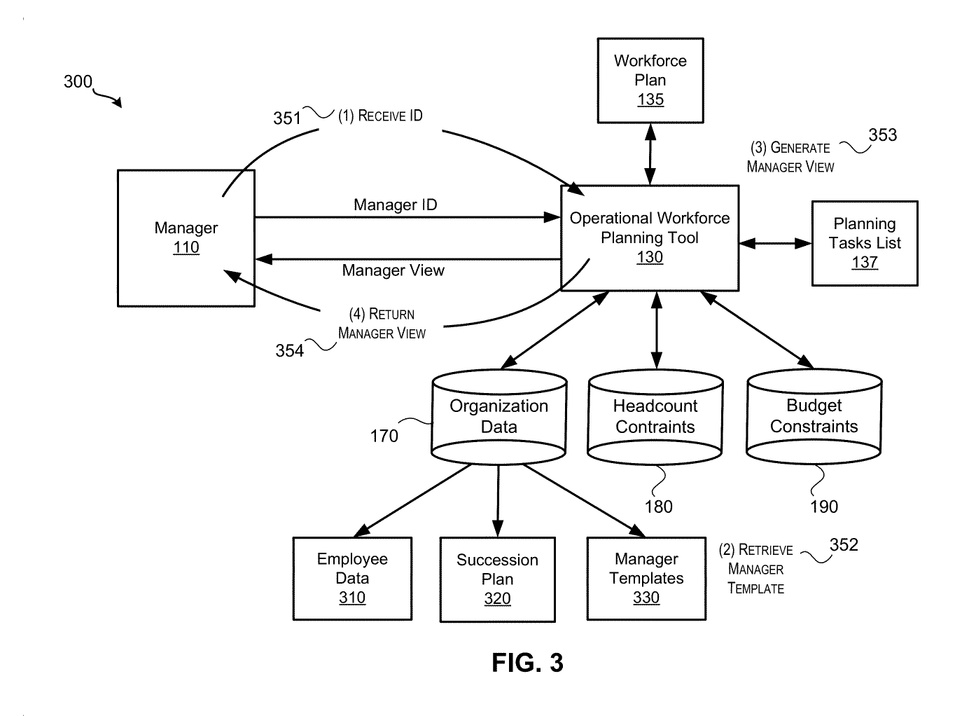

FIG. 3 illustrates a system for generating a manager view according to one embodiment. System 300 includes manager 110, operational workforce planning tool 130, workforce plan 135, planning tasks list 137, organization data 170, headcount constraints 180, and budget constraints 190. Organization data 170 includes employee data 310, succession plan 320, and manager templates 330. Employee data 310 can include metadata on employees within the organization including employee compensation, employee tenure, employee performance metrics, employee potential metrics, employee role, and employee skills. Headcount constraints 180 and budget constraints 190 can define the headcount and budget constraints, respectively, for each division, department, and/or team.

Procedurally to generate a manager view, the operational workforce planning tool 130 can first receive a manager ID at step 351. The manager ID can be received from a client device operated by manager 110. Once the manager ID is received, operational workforce planning tool 130 can retrieve a manager template that corresponds with the manager ID from manager templates 330 at step 352. The manager template defines the layout of the manager view. For example, the manager template can define which charts and graphs are presented in the manager view. Organizational workforce planning tool 130 can then generate the manager view at step 353. Generating the manager view can include retrieving headcount constraints and budget constraints based on the manager ID from headcount constraints 180 and budget constraints 190. These constraints are presented as part of the manager view so that the manager is aware of the limitations to the changes which can be made to the workforce plan. Generating the manager view can also include retrieving relevant information for the manager from organization data 170, which includes data from employee data 310 and optionally succession plan 320. The information retrieved can depend on the manager ID and the manager template. The charts that are a part of the manager template can affect which dimensions of information are retrieved from organization data 170, headcount constraints 180, and budget constraints 190. In one example, the current headcount and the current spending for the manager can be retrieved from employee data 310. Once the manager view has been generated, operational workforce planning tool 130 can return the manager view to manager 110 at 354. This can include transmitting the manager view to a client device operated by manager 110.

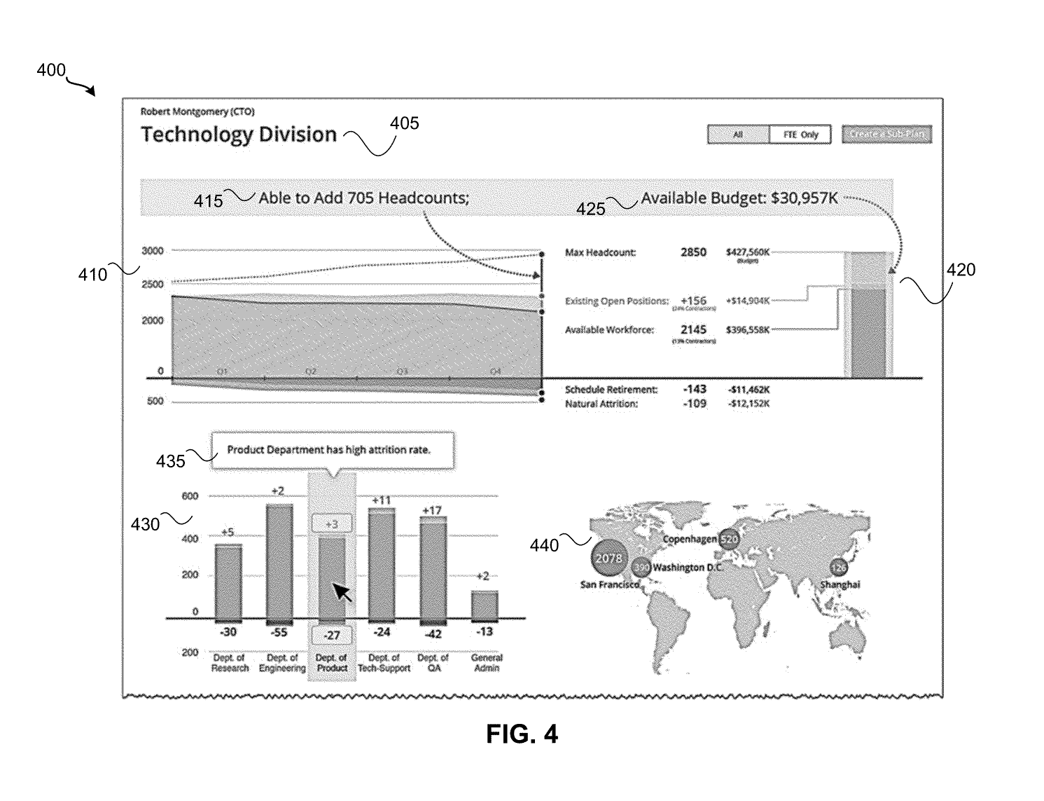

FIG. 4 illustrates an example of a manager view according to one embodiment. Manager view 400 includes header 405 which lists the manager's name, role, position and/or the groups that the manager manages. Here, the manager is named Robert Montgomery, his role is as the CTO of the organization, and he manages the technology division. Manager view 400 also includes multiple charts. The types of charts that are presented along with the positioning of the charts within manager view 400 is dependent on the manager template. As described above, the operational workforce planning tool 130 can generate manager view 400 according to a manager template that corresponds with the manager.

Here, manager view 400 includes chart 410 which plots the change in headcount over time. Chart 410 includes information on the available workforce (e.g., existing workforce), existing open positions, scheduled retirement, and natural attrition. The available workforce is the existing number of employees who are in the technology division and the existing open positions are the open positions that are currently available. Scheduled retirement is the number of people who are scheduled to retire at the end of the quarter while natural attrition is the estimated number of employees who will leave the organization by the end of the quarter.

Chart 415 can be presented along with notification 415. Notification 415 is configured to notify the manager on the total number of employees that can be added to the technology division. The total number of employees that can be added to the organization can be based on the existing employees in the group/team, the existing open positions in the group/team, the headcount constraints for the group/team, the scheduled retirement of members in the group/team, and/or the estimated natural attrition of members in the group/team. For example, the headcount constraint on the team can be subtracted from the existing workforce to determine the number of positions that are available to add to the team. As another example, the headcount constraint can be subtracted from the available workforce, followed by the addition of the scheduled retirement and natural attrition (since these are employees leaving the organization, thus freeing up additional positions for additional hires or transfers). In one embodiment, the notification presented can be predefined in the manager template. For example, the manager template can be configured to always present a notification on the total number of employees that can be added during workforce planning.

Manager view 400 further includes chart 420 which plots the headcount along with the budgets. As shown, chart 420 is configured to supplement chart 410. Chart 420 is a bar graph which presents the spending for each group of employees as a segment of the bar chart. Numbers corresponding to the budget spent for each group of employees is also presented in chart 420. Chart 420 further includes notification 425 which is configured to notify the manager the total available budget for the technology division. The total available budget can be based on the spending on the existing employees in the group/team, the budget available for open positions in the group/team, the budget constraints for the group/team, and the available budget that will become available due to scheduled retirement of members in the group/team and the estimated natural attrition of members in the group/team.

Manager view 400 further includes chart 430 which plots the headcount of the various departments that belong in the technology division. As shown, each bar (i.e., data marker) in chart 430 can present the number of existing employees within the department, the number of newly joined employees within the department, and the number of employees that are no longer with the department. As a result, each bar can describe the changes to the headcount within the department during a predefined period of time. Here, the predefined period of time is four quarters, which translates to a single year. The height of the bar can represent the total number of employees that are currently assigned to the department, taking into consideration attrition (people leaving the department) and new members of the department (people joining the department, either through transfer or as a new hire). In other charts, other types of data markers can be used to represent data.

Chart 430 also includes warning 435. The manager template can be configured to present a warning in chart 435 when a condition is met or when a rule is violated. In one example, the condition can be the ratio of employees leaving the department and the employees joining the department is above a predefined threshold. In another example, the condition can be when the total headcount for a department falls below a predefined threshold. In yet another example, the condition can be an attrition rate (e.g., the rate in which employees are leaving the department. The rate can be measured per quarter, year, or other predefined interval). In yet other examples, the condition can be a combination of one or more of these conditions described above. Here, warning 435 is presented in chart 430 because the attrition rate of the product department is above a predefined threshold. Warning 435 is configured to warn the manager of the high attrition rate in the product department. The manager can react to warning 435 by assigning more new positions to the product department to counteract the high attrition rate. Alternatively, the manager can examine the product department to identify the cause of the high attrition rate (potentially a poor lower level manager) and to remedy the issue.

Manager view 400 further includes 440 which plots the headcount of employees in the technology division across various geographical locations. As shown, chart 440 illustrates that most employees are located in San Francisco and the fewest employees are located in Shanghai. In some embodiments, manager view 400 can include additional charts that are viewable through scrolling. For instance, the manager template can include a plurality of charts that extend past the viewable area on the client device. As a result, the resulting manager view can be scrollable. This is illustrated by the jagged line at the bottom of manager view 400.

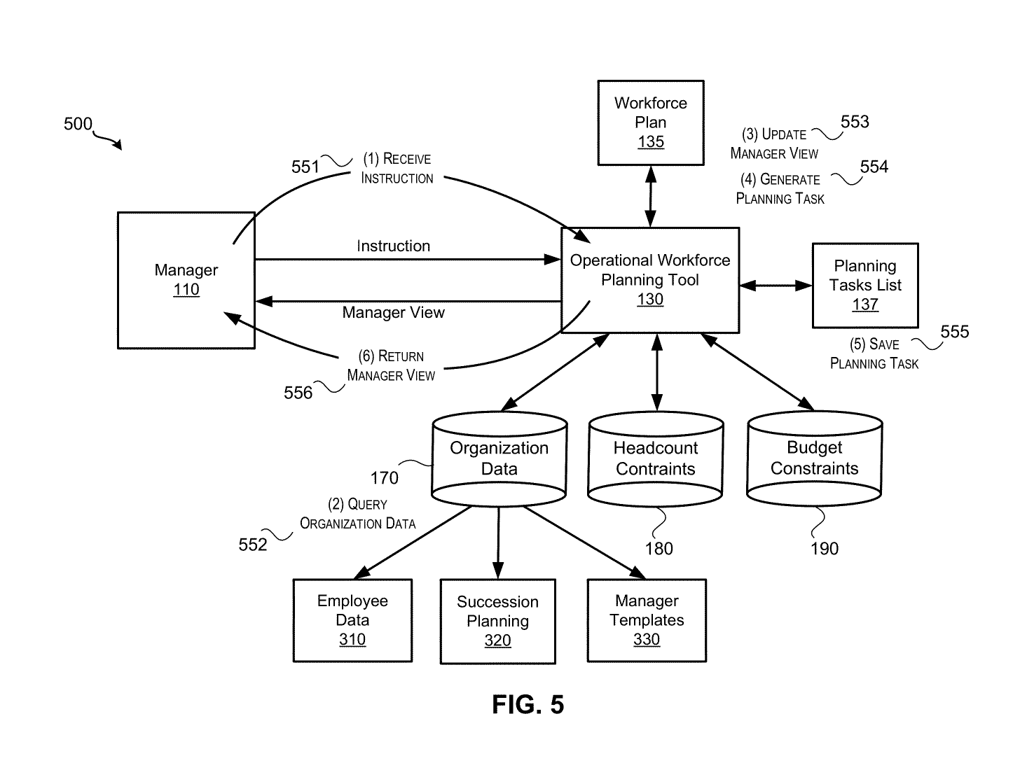

FIG. 5 illustrates a system for updating a manager view according to one embodiment. System 500 includes manager 110, operational workforce planning tool 130, workforce plan 135, planning tasks list 137, organization data 170, headcount constraints 180, and budget constraints 190. Organization data 170 includes employee data 310, succession plan 320, and manager templates 330. Employee data 310 can include metadata on employees within the organization including employee compensation, employee tenure, employee performance metrics, employee potential metrics, employee role, and employee skills. Headcount constraints 180 and budget constraints 190 can define the headcount and budget constraints, respectively, for each division, department, and/or team.

Procedurally to update a manager view, the operational workforce planning tool 130 can first receive an instruction from manager 110 at step 551. The instruction can be received as a request from manager 110. The instruction can be generated when the manager interacts with the manager view presented on the client device operated by the manager. For example, an instruction can be generated by the client device when the manager selects an element of a chart within the manager view. Operational workforce planning tool 130 can process the received instruction by first querying organization data 170 for data at step 552. For example if the received instruction is to for additional details on an element of a chart, operational workforce planning tool 130 can query organization data 170 for the additional details on the element. For instance, operational workforce planning tool 130 can retrieve additional details on the product department when an instruction is received that the manager has selected the element “Dept. of Product” in chart 430 of FIG. 4.

Once the organization data has been received, operational workforce planning tool 130 can update the manager view at 553. Updating the manager view can include the presentation of the additional details retrieved from organization data 170. In some instances where the instructions are to modify the workforce plan, operational workforce planning tool 130 can generate a planning task at step 554. The planning task can describe a change to workforce plan 135. The planning task can identify an employee or new hire, the old position of the employee or new hire (if any), and identify the new position of the employee or new hire (if any). The planning task can also have a state and a list of approvers. The planning task can remain in a submitted state while the list of approvers have not approved the planning task. The planning task can switch to a committed state when the list of approvers have approved the planning task. In one embodiment, the list of approvers can automatically be populated according to the organizational hierarchy. For example, operational workforce planning tool 130 can automatically select the upper level managers of a lower level manager as approvers. In another embodiment, operational workforce planning tool 130 can automatically include in the list of approvers the managers of the two teams which an employee is being transferred to. The manager who is initiating the transfer can approve the transfer by default.

If the instruction results in the generation of a planning task, operational workforce planning tool 130 can optionally save the planning task in planning tasks list 137 at step 555. Once the planning task has been saved, operational workforce planning tool 130 can automatically return the updated manager view to manager 110 at 556. The updated manager view can be received by a client device operated by manager 110 and presented on a display of the client device for manager 110 to review.

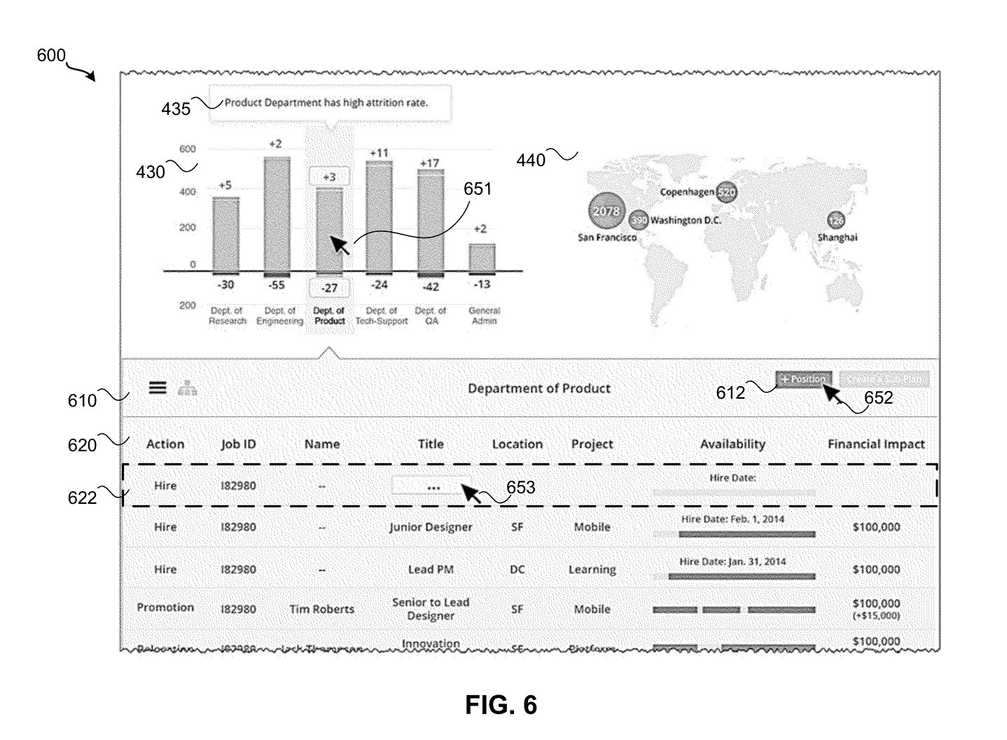

FIG. 6 illustrates an updated manager view according to one embodiment. Manager view 600 can be an updated view of manager view 400 that is transmitted to the manager in response to receiving touch event 651 and touch event 652. A manager can review warning 435 of chart 430 and decide to investigate the high attrition rate in the product department. As a result, the manager can trigger touch event 651 when the manager touches the bar within chart 430 that is associated with the product department. The client device can transmit touch event 451 to operational workforce planning tool 130 which in turn generates an updated manager view for manager view 400. The updated manager view can include window 610 that includes a table containing the existing employees and open positions that are within the product department. The table can include the attributes of the employee (or open position). The attributes include an action associated with the employee, the job ID, the name of the employee (if any), the title of the position, the location, the project, the availability, and the financial impact. In one embodiment, the job ID can be unique for each position within the organization. In one embodiment, the table can be table 620 but without new entry 622.

Window 610 can also include selectable icon 612. Selectable icon 612, when selected, generates an instruction to create a new position in the selected department. Touch event 652 selects selectable icon 612. The client device can generate the instruction and transmit the instruction to operational workforce planning tool 130 when touch event 652 occurs. Operational workforce planning tool 130 can process the instruction and create updated manager view 600, which includes table 620 and entry 622, which is a new entry for creating a new position in the product department. In one embodiment, one or more attributes of entry 622 can be automatically populated. The one or more attributes can be populated according to the context of the manager view when touch event 652 is received. The context can be derived from what is currently being displayed in the manager view when touch event 652 is detected. For example, the action attribute can automatically be set to “hire” and the job ID attribute can be automatically set to the next available unique ID. Other attributes such as the title of the position and the location of the position can be left empty to be filled out by the manager. In one example, one or more fields of the new entry can be automatically populated based on the selection of chart 430. Properties of chart 430 can be used to automatically populate the new entry. In another example, one or more fields of the new entry can be automatically populated based on the selection of a data marker by touch event 651. Properties of the data marker can be used to automatically populate the new entry.

Touch event 653 can be used to set the title of entry 622. Similarly, other touch events can be used to set other attributes of entry 622. Once entry 622 has been filled out, operational workforce planning tool 130 can generate a new planning task based on entry 622. The approvers list, which can be a part of the planning task, can be automatically set and stored with the planning task.

### Cascading Sub-Plans

A manager can generate planning tasks to adjust the workforce plan until the manager's planning criteria is satisfied. The planning criteria can include goals such as hiring enough employees for a project while considering headcount and budget constraints. The planning tasks can be combined to form a local plan that describes the changes proposed by the manager. The local plan can be reviewed by approvers and if approved, implemented into the workforce plan. In some embodiments, an upper level manager can reassign a planning criteria or a subset of a planning criteria to a lower level manager, thus reducing the time that the upper level manager spends on workforce planning. The upper level manager can create a sub-plan (which contains the reassigned planning criteria or new planning criteria assigned by the upper level manager) and assign the sub-plan to a lower level manager. The lower level manager can be a manager that directly reports to the upper level manager. The lower level manager can generate planning tasks to complete the sub-plan while the lower level manager is completing his own planning criteria. Upon completion of the lower level manager's planning criteria and any planning criteria that has been assigned by the upper level manager through the sub-plan, the lower level manager will have generated a local plan. The local plan can be rolled up to the upper level manager for review and approval. The upper level manager also have a local plan that includes the upper level manager's planning tasks and the planning tasks of the lower level manager which the upper level manager has approved. This local plan also be rolled up for review by other approvers.

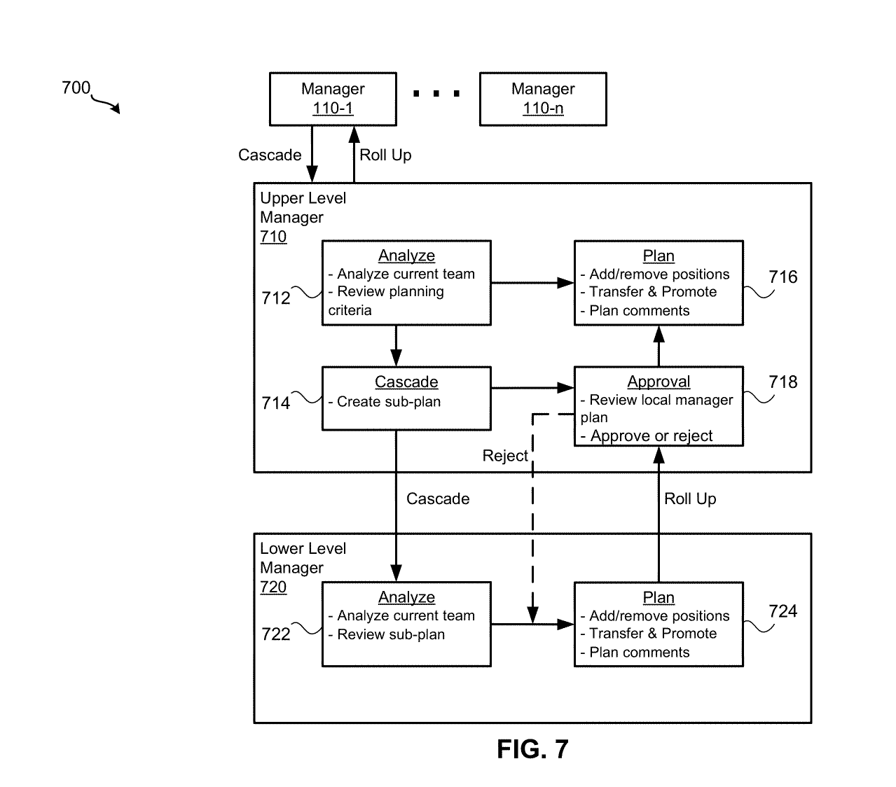

FIG. 7 illustrates a planning process according to one embodiment. Planning process 700 includes managers 110-1 to 110-n, upper level manager 710, and lower level manager 720. Manager 720 directly reports to manager 710, who directly reports to manager 110-1. Higher level managers can cascade sub-plans to lower level managers. Lower level managers can complete the sub-plans and roll them up to the higher level managers for review.

Process 700 can begin at analyze phase 712. In analyze phase 712, manager 710 can analyze the current team and review planning criteria. The planning criteria can include goals for the current team, budget information on the current team, and headcount information on the current team. The budget and headcount information can include the current budget/headcount and constraints on the budget/headcount. Manager 710 can interact with a manager view to request analysis on the current team. Operational workforce planning tool 130 can update the manager view to in response to the interactions to provide analysis on the current team to manager 710.

After analyze phase 712, manager 710 can continue to plan phase 716 or cascade phase 714. In plan phase 716, manager 710 can create planning tasks such as adding/removing positions or transferring/promoting employees. Manager 710 can transmit instructions to operational workforce planning tool 130 for generating the planning tasks. Operational workforce planning tool 130 can process the instructions to generate the planning tasks. Operational workforce planning tool 130 can also update the manager view in response to the generated planning tasks.

Alternatively, manager 710 can continue to cascade phase 714 where manager 710 can create a sub-plan for manager 720. In one embodiment, the sub-plan can include one or more planning criteria that are the responsibility of manager 710. In other words, manager 710 can reassign planning criteria to manager 720. In another embodiment, the sub-plan can include planning criteria generated by manager 710. Manager 710 can generate planning criteria for manager 720 which when completed, advance the completion of a planning criteria that manager 710 in responsible for. For example, the sub-plan can include sub-goals which when completed, help advance a goal or planning criteria of manager 710. Manager 710 can interact with the manager view to generate instructions for creating the sub-plan. The instructions are transmitted to operational workforce planning tool 130 which in turn generates the sub-plan and stores the sub-plan as part of the workforce plan. The sub-plan can include a source field designating the manager who generated the sub-plan, a recipient field designating the manager who is being assigned the sub-plan, and planning criteria.

If a sub-plan has been generated, operational workforce planning tool 130 can cascade down the sub-plan to manager 720. In one embodiment, operational workforce planning tool 130 can transmit a sub-plan to the recipient of the sub-plan when the sub-plan is generated. Transmitting the sub-plan to the recipient can include identifying the client device that is being operated by the recipient and then transmitting the sub-plan to the identified client device. Here, the recipient is manager 720. Once manager 720 receives the sub-plan, manager 720 can continue to analyze phase 722. In analyze phase 722, manager 720 can analyze the current team (e.g., the team that manager 720 manages) and review the sub-plan. Manager 720 can optionally also review any planning criteria assigned to manager 720. Manager 720 can interact with a manager view to request analysis on the current team. The manager view can be presented on a client device operated by manager 720. Operational workforce planning tool 130 can update the manager view to in response to the interactions to provide analysis on the current team to the manager 720.

After analyze phase 722, manager 720 can continue to plan phase 724. In plan phase 722, manager 720 can create planning tasks such as adding/removing positions or transferring/promoting employees. Manager 720 can transmit instructions to operational workforce planning tool 130 for generating the planning tasks. Operational workforce planning tool 130 can process the instructions to generate the planning tasks. Operational workforce planning tool 130 can also update the manager view in response to the generated planning tasks. Plan comments can also be included as part of the planning tasks. The combination of the generated planning tasks can form a local manager plan that corresponds with manager 720.

At the completion of plan phase 724, operational workforce planning tool 130 can roll up the local manager plan to manager 710. In one embodiment, operational workforce planning tool 130 can automatically transmit the local manager plan to manager 710 (whom is a direct manager of manager 720) for review. Transmitting the local manager plan can include identifying a client device that is operated by manager 710 and transmitting the local manager plan to the identified client device. When the client device receives the local manager plan, a notification can be presented in the manager view to notify manager 710 that manager 720 has completed workforce planning. Once manager 710 has received the local manager plan, manager 710 can continue to approval stage 718. In approval stage 718, manager 710 can be presented the local manager plan in the manager view. Manager 710 can review the local manager plan and decide to accept or reject some/all of the local manager plan. Upon detecting rejected portions of the local manager plan, operational workforce planning tool 130 can return the rejected portions to manager 720 where manager 720 can repeat planning phase 724.

Once the local manager plan has been approved, manager 710 can optionally continue to plan phase 716. As described above, manager 710 can create planning tasks. Planning tasks can be created in plan phase 716 to address any planning criteria that is not yet satisfied after rolling up the local manager plan from manager 720. In one embodiment, planning tasks created by manager 720 can be incorporated into the manager view for manager 710 so that manager 710 can determine what is still needed to complete any outstanding planning criteria. Once manager 710 has completed his responsible planning criteria, the planning tasks created by manager 710 plus the planning tasks created by manager 720 can be combined as a local manager plan that is associated with manager 710. This local manager plan can be rolled up to manager 110-1 for review. In one embodiment, operational workforce planning tool 130 can verify that a manager has completed assigned planning criteria before rolling up the local manager plan to a higher level manager. Verification can include checking whether planning criteria has been completed or checking whether budget/headcount constraints have not been violated.

In one embodiment, one or more phases of process 700 can be performed simultaneously. For example, manager 710 can be performing plan phase 716 while manager 720 is performing plan phase 724. This allows manager 710 to continue his portion of workforce planning while manager 720 is completing his portion of workforce planning. When manager 720 completes his local manager plan, operational workforce planning tool 130 can transmit the local manager plan of manager 720 to manager 710 for review. The local manager plan of the lower level manager 720 can be incorporated into the local manager plan of the upper level manager 710.

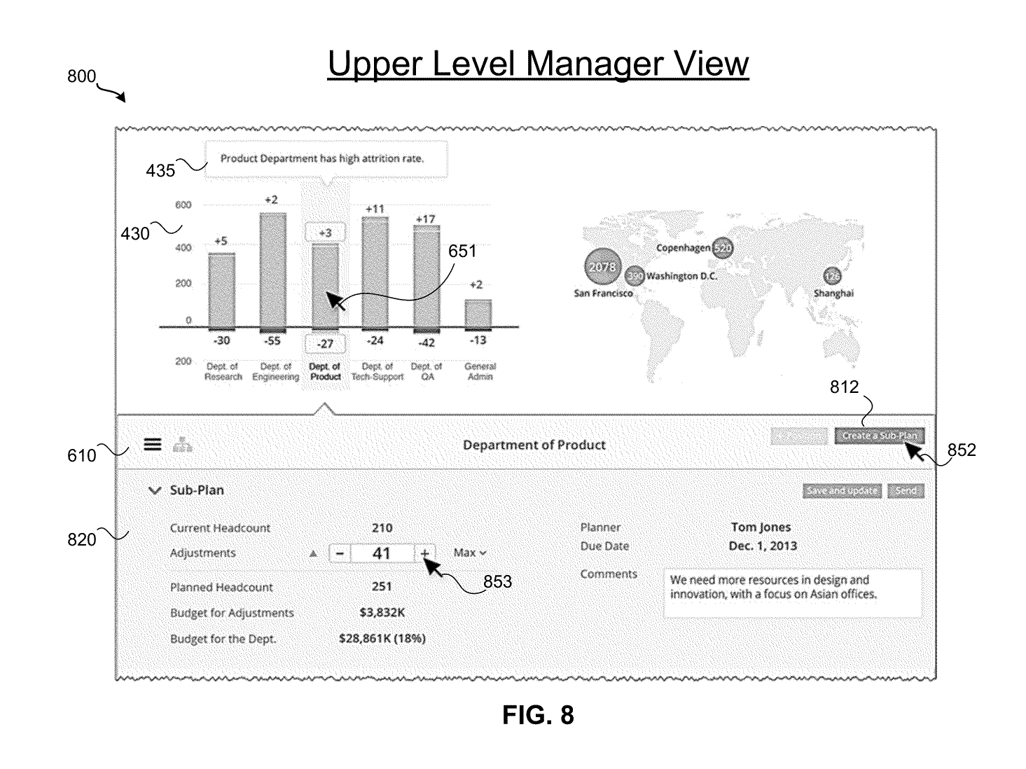

FIG. 8 illustrates an upper level manager view according to one embodiment. Manager view 800 can be associated to manager 710 in FIG. 7. As shown, manager view 800 includes chart 430. Detecting touch event 651 on chart 430 can cause operational workforce planning tool 130 to present window 610 in manager view 800. Window 610 includes selectable icon 812 which is configured to create a sub-plan when selected. Detecting touch event 652 on selectable icon 812 can cause operational workforce planning tool 130 to display form 820 which is used for generating a sub-plan. As shown, form 820 for generating a sub-plan can include a plurality of fields which are used to define the sub-plan. Form 820 can include an adjustments field which allows manager 710 to set the adjustments to the headcount that he would like manager 720 to be responsible for. In one embodiment, adjustments field can be selectable which allows manager 710 to modify the adjustments via touch event 853. Form 820 can also include a budget field that allows manager 720 to set the available budget that manager 720 has available to him when working on the sub-plan. Form 820 can also include a planner field that allows manager 710 to set the lower level manager who will be responsible for completing the sub-plan. In instances where there is only one lower level manager, the planner field can be automatically set. Alternatively, the planner field can also be automatically set based on the person managing the team which the sub-plan is being created for. For example, if the sub-plan is being created for the product department, then the manager of the product department can be automatically filled as the planner. Form 820 can also include a due date field which allows manager 710 to specify when the sub-plan is to be completed. Form 820 can also include a comments field which allows manager 710 to leave a note for manager 720. The note can explain the rationale for the sub-plan or provide additional considerations when completing the sub-plan.

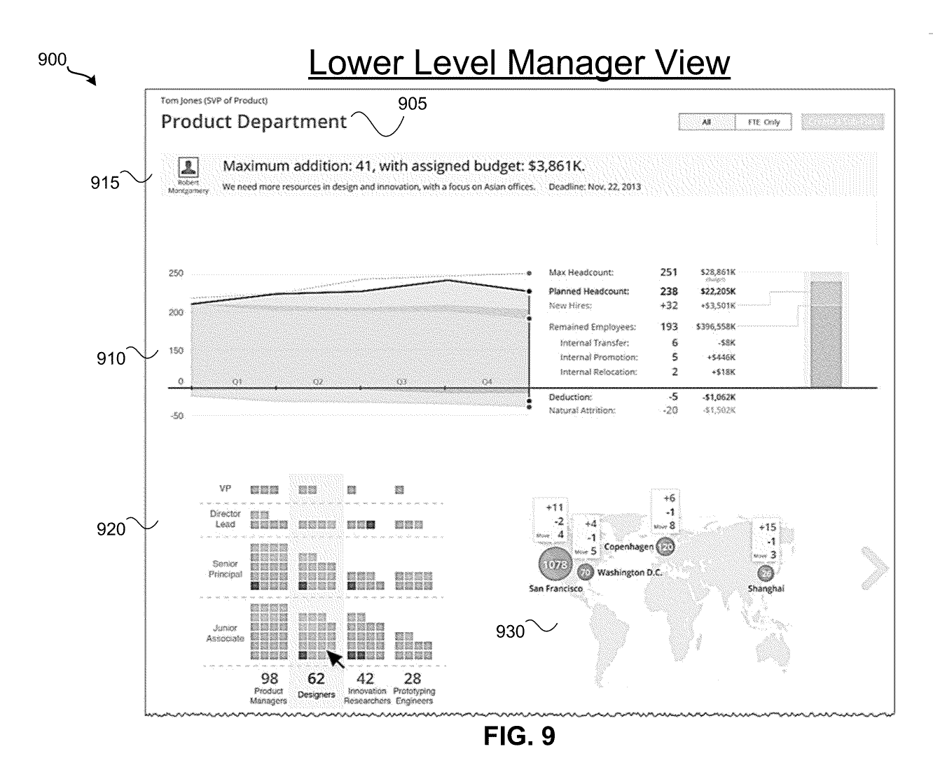

FIG. 9 illustrates a lower level manager view according to one embodiment. Manager view 900 can be associated with manager 720 of FIG. 7. As shown, manager view 900 includes header 405. Header 905 can list the manager's name, role, position, and/or the groups that the manager manages. Here, header 905 presents the manager's name as Tom Jones, his position as senior vice president (SVP) of product, and that he manages the product department. Manager view 900 further includes charts 910, 920, and 930. The positioning and the selection of charts can be specified by a manager template that corresponds with the manager. The data used to populate the charts can be data that is relevant to the manager. Thus, the charts of the lower level manager can be based on a subset of the data used in the charts of an upper level manager.

Manager view 900 further includes notification 915. Notification 915 notifies the manager that a sub-plan has been submitted for the manager from an upper level manager. Notification 915 can present one or more fields of the sub-plan. Here, notification 915 includes the adjustment field of the sub-plan which specifies that the manager can add a maximum of 41 employees to the product department. Notification 915 also presents the assigned budget which the manager has available to him when adding the 41 employees. Notification 915 can also present a comments section and the due date of the sub-plan.

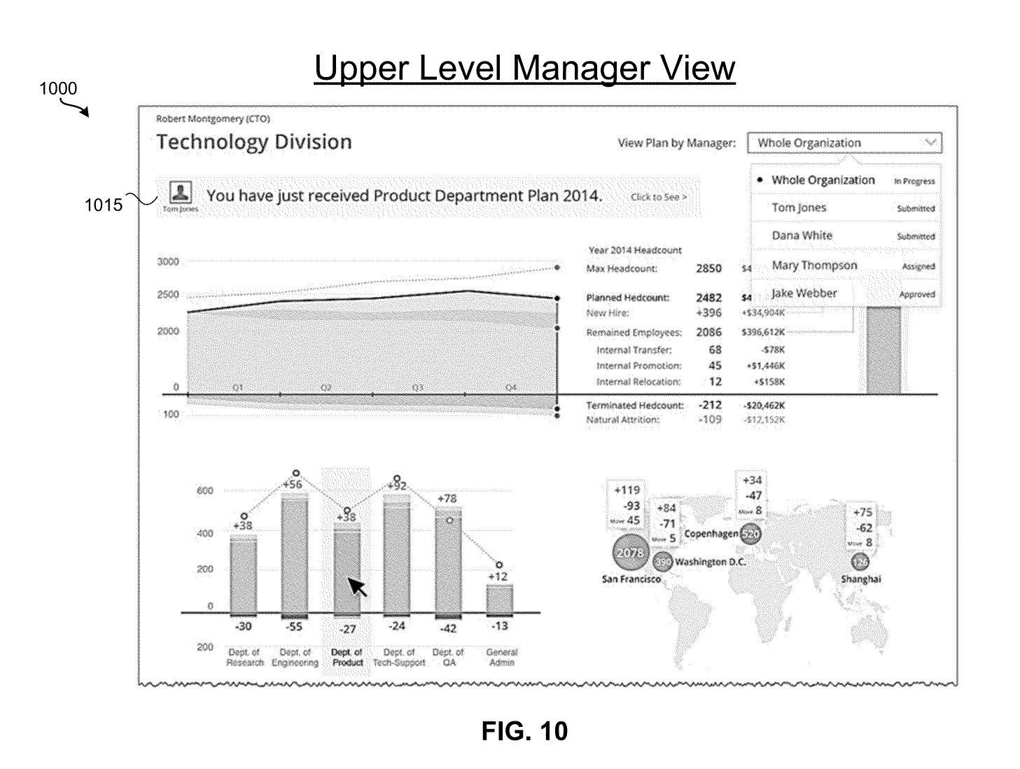

FIG. 10 illustrates another upper level manager view according to one embodiment. Manager view 1000 can be associated with manager 710 of FIG. 7 and can be an updated view of manager view 800 of FIG. 8. As shown, manager view 1000 includes notification 1015. Notification 1050 is configured to notify manager 710 that the local manager plan that corresponds with manager 720 is ready for review. Selecting notification 1050 can cause the local manager plan of manager 720 to be displayed in the manager view of manager 710. Manager 710 can review the plan and decide to approve/reject some or all of the plan.

### Transferring Employees Between Teams

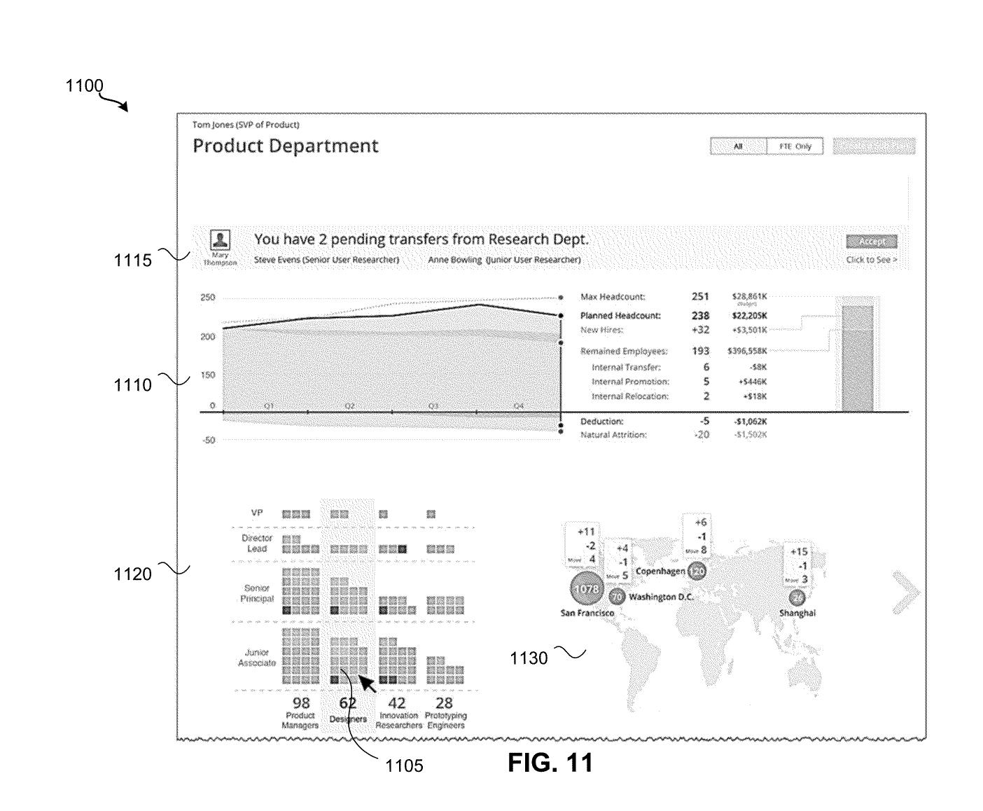

As described above, a manager can transfer an employee within the manager's team to another team managed by another manager. In some embodiments, the manager view can include notifications and icons which can simplify the transfer process. FIG. 11 illustrates a manager view according to one embodiment. Manager view 1100 can include charts 1110, 1120, and 1130. Each chart can present analysis on the manager's team (or teams). Selecting one of the charts can result in manager view 1100 being updated to present details on the manager's team. Manager view 1100 further includes notification 1115. Notification 1115 is configured to notify the manager of pending transfers. Here, notification 1115 notifies the manager Tom Jones that there are two pending transfers from Mary Thompson of the research department. The names of the pending transfers are also provided (Steve Evens and Anne Bowling).

In some embodiments, one or more elements within manager view 1100 can be actionable. For example, a touch event triggered on notification 1115 can cause manager view 1100 to be updated to present details on a team which has an incoming pending transfer. Alternatively, a touch event triggered on chart element 1105 in chart 1120 can also cause manager view 1100 to be updated to present details on the team that corresponds with chart element 1105.

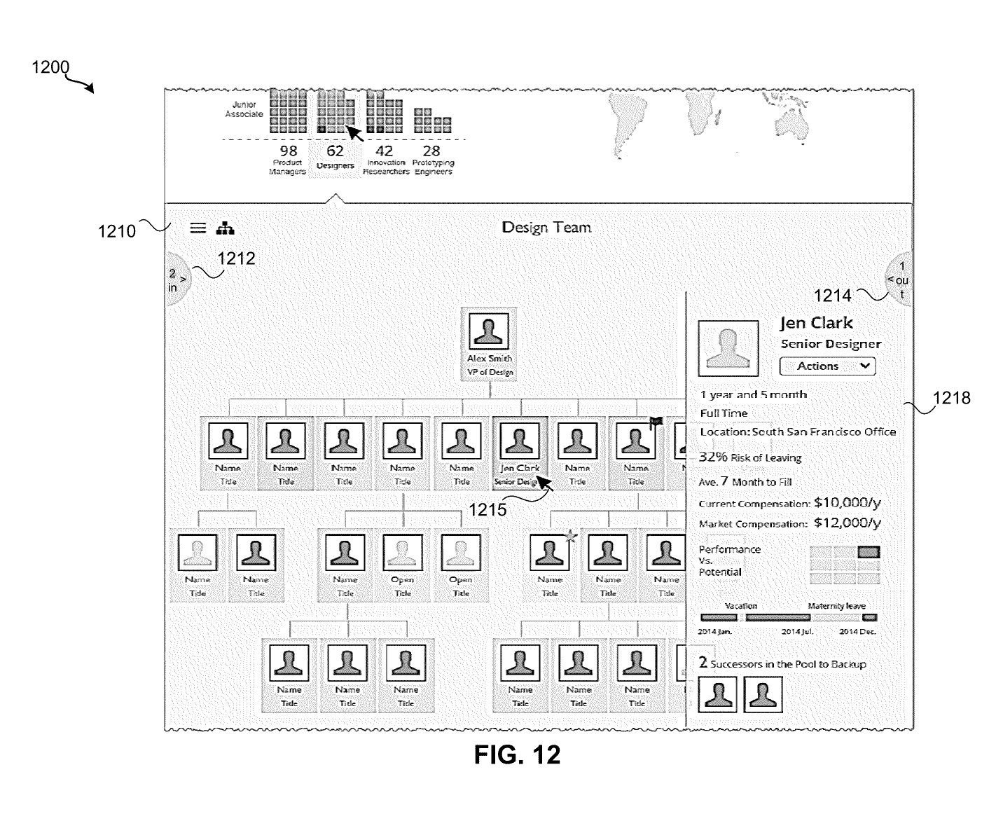

FIG. 12 illustrates another manager view according to one embodiment. Manager view 1200 can be an updated view from manager view 1100 of FIG. 11. In one embodiment, manager view 1200 can be presented when chart element 1105 or notification 1115 is selected in manager view 1100. Manager view 1200 includes window 1210. Window 1210 is configured to present an organizational chart of the design team. The organizational chart includes a plurality of tiles that are connected with lines to illustrate the relationships between team members. For example, a line connecting two team members where a first team member is positioned above a second team member can represent that the second team member directly reports to the first team member.

Window 1210 can include transfer-in icon 1212 and transfer-out icon 1214. Transfer-in icon 1212 and transfer-out icon 1214 are configured to notify the manager of incoming and outgoing transfers. Transfer-in icon 1212 can be presented with a number in the middle signifying the number of incoming transfers that are pending. Here, transfer-in icon 1212 states that there are two pending transfers. Similarly, transfer-out icon 1214 can be presented with a number in the middle signifying the number of outgoing transfers that are pending. Here, there is one outgoing transfer pending. In one embodiment, the transfer icons can be configured to disappear or be shaded when there are no pending transfers.

In one embodiment, each tile within the organization chart can be actionable where selecting the tile can cause additional details on the team member that corresponds with the tile to be displayed. Window 1210 includes tile 1215 that corresponds to a team member named Jen Clark. When operational workforce planning tool 130 can update manager view 1200 to include pop-up window 1218 when operational workforce planning tool 130 detects that tile 1215 has been selected. Pop-up window 1218 can present additional details on the team member. The additional details can include the role of the team member, the term of employment, the office location which the team member works out of, the team member's current compensation, the market compensation for rate for an employee having the same role, a measurement of performance, a measurement of potential, vacation data, succession data, and other data. The additional details can also include a voluntary termination rate. The voluntary termination rate can predict the likelihood that the team member will voluntarily leave the organization within the next year. The voluntary termination rate can be presented along with an estimate to the amount of time it takes to fill that role.

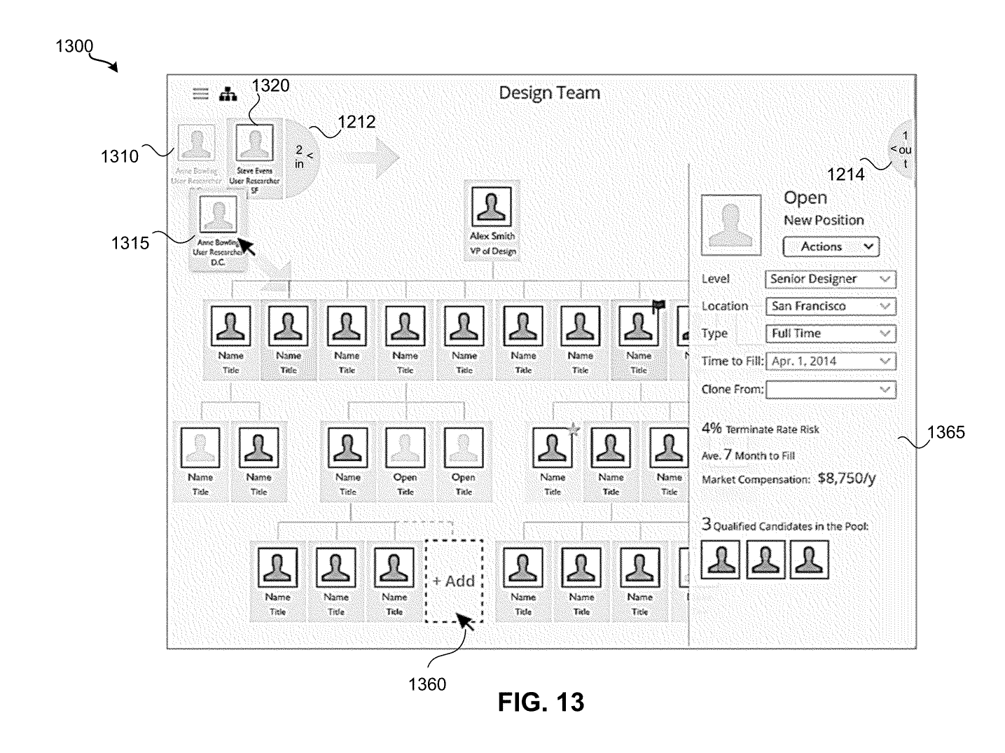

FIG. 13 illustrates a window containing an organizational chart according to one embodiment. As shown here, transfer-in icon 1212 has been selected thus causing the pending incoming transfers to be presented in window 1300. Tile 1310 represents pending transfer Anne Bowling while tile 1320 represents pending transfer Steve Evens. Each tile can be actionable where the tile can be touched and dragged to an open position in the organizational chart. Once the tile is placed in the open position, operational workforce planning tool 130 can create a planning task to transfer the team member from a first team to a second team. Here, tile 1315 (which represents pending transfer Anne Bowling) is being dragged around the organizational chart. A visual cue can be applied to the initial position of tile 1315 so that the manager can see where the team member was originally positioned in the organizational chart. Here, tile 1310 which is shaded can represent the original position of Anne Bowling, the original position being the incoming pending transfers area of window 1300. If the manager were to try and reassign a team member from a first position in the team to a second position in the team, the first position of the team member would be shaded or differentiated using some other visual cue to help the manager identify where the team member's current position in the team.

In some embodiments, operational workforce planning tool 130 can create a new position in a team based on user input received in window 1300. For example, a new position can be created when operational workforce planning tool 130 detects that the manager is hovering over an empty space in the organizational chart. Here, pointer 1360 is hovering over an empty space in the organizational chart presented in window 1300. If the pointer is hovering over the empty space for a predefined period of time, operational workforce planning tool 130 can create a new position in the team. The relationships of the new position can be automatically defined based on the location of pointer 1360. Pop-up window 1365 can be presented in window 1300 so that details of the new position can be specified by the manager. Some of the details of the new position can be automatically populated. In one embodiment, the one or more details can be automatically populated according to the location within the organizational chart that the new position is being created. For example, a new position created at the location of pointer 1360 can be automatically set to share the same manager as the neighboring tiles. In another embodiment, one or more details can be automatically populated according to the attributes of a team member being transferred in. Operational workforce planning tool 130 can predict that the new position is for an incoming transfer and set one or more details of the new position to match details of the incoming transfer. For example, the level of the new position and the location of the new position can be automatically set to the level and location of the incoming transfer.

### Recommending Transfers

As described above, a manager can add or remove positions from teams during the plan phase. Adding positions can include the creation of a new position in a team (which can later be filled) or adding a new team member (i.e., existing employee or new hire) to the team (to fill an existing open position or a new position). Removing positions can include removing existing open positions that have yet to be filled or terminating an employee from the team (leaving the position of the terminated employee open or removing the position). In some embodiments, operational workforce planning tool 130 can be configured to provide recommendations to the manager when a new position is created in the team or when an employee is terminated from the team. The recommendation can be an employee from a different team that may be a good candidate for the new position or vacant position.

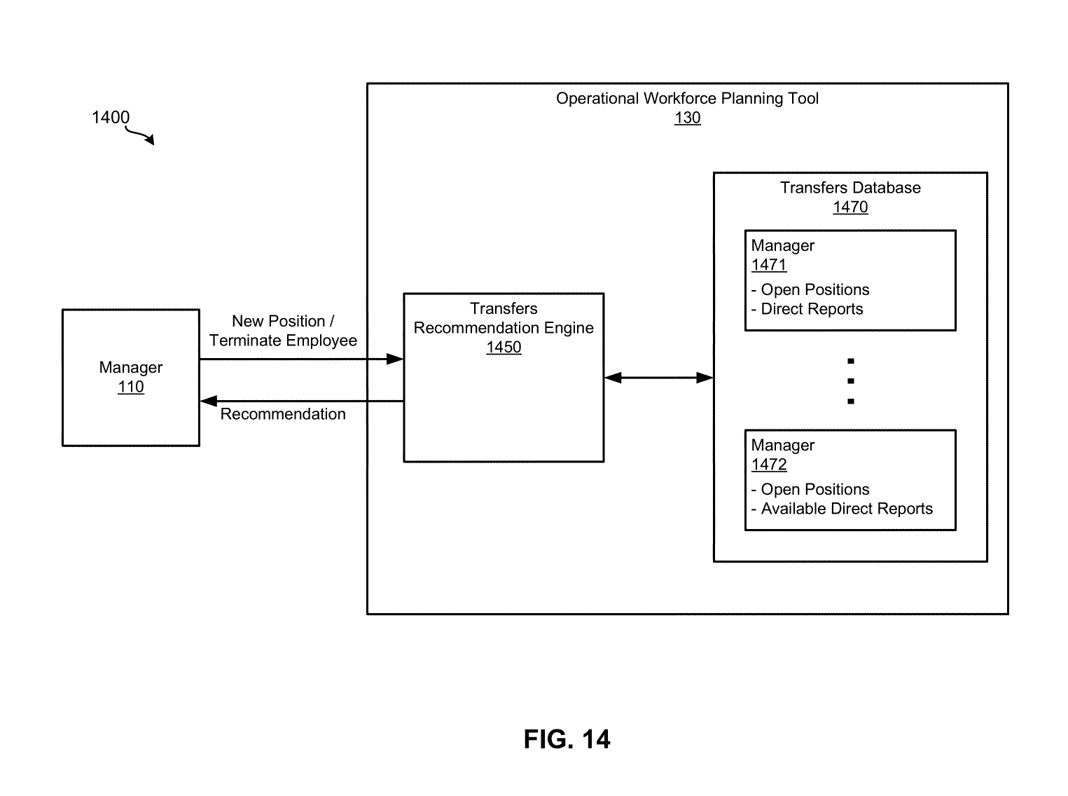

FIG. 14 illustrates a system for recommending transfers according to one embodiment. System 1400 includes manager 110 and operational workforce planning tool 130. Operational workforce planning tool 130 includes transfers recommendation engine 1450 and transfers database 1470. Transfers database 1470 can be a database that stores the open positions and direct reports of a manager. Here, the open positions and direct reports of manager 1471 and manager 1472 can be identified within transfers database 1470. In one embodiment, transfers recommendation engine 1450 is configured to recommend an existing open position in another manager's team when it detects that manager 110 has terminated an employee. Manager 110 may need to terminate an employee because of lack of resources available to manager 110, thus forcing manager 110 to downsize the team. Instead of terminating the employee from the organization, manager 110 can attempt to transfer the employee to another team. This can be particularly true if the employee is a high performer.

In response to detecting a modification request from manager 110 to edit a team (e.g., that an employee has been terminated from a team), transfers recommendation engine 1450 can query transfers database 1470 for an open position in another manager's team which the terminated employee may be qualified for. In one example, transfers recommendation engine 1450 can query transfers database 1470 for open positions in other manager's teams and match an attribute or skill of the terminated employee with a requirement of the open position. Attributes can be a specific role in the organization while skills can be specific skill sets that are desired or required for the open position. Transfers recommendation engine 1450 can determine that the terminated employee is qualified for a position by matching the requirements of an open position against the attributes or skills of the terminated employee. If the terminated employee is qualified for one or more open positions, transfers recommendation engine 1450 can generate a recommended action for each of the qualified open positions. Each recommended action can be to transfer the terminated employee to an open position which the terminated employee is qualified for. Transfers recommendation engine 1450 can transmit the recommended actions to manager 110 for review. Manager 110 can review the recommended actions and if one is appropriate, can transmit a confirmation to transfers recommendation engine 1450 that manager 110 would like to accept a recommended action.

At this point, manager 110 has suggested transferring the terminated employee to another manager's group. In one embodiment, transfers recommendation engine 1450 can generate a planning task to transfer the terminated employee to the receiving manager's group upon receiving confirmation from manager 110. The receiving manager can accept or reject the planning task during workforce planning. In another embodiment, transfers recommendation engine 1450 may wait until the receiving manager approves the transfer before a planning task can be generated to transfer the terminated employee to the receiving manager's team. This can reduce the number of planning tasks that are presented to the receiving manager. Furthermore, this allows the receiving manager to place the terminated employee in an open position before the planning task is generated. To seek approval from the receiving manager, transfers recommendation engine 1450 can generate a transfer request and transmit the transfer request to the receiving manager for approval. The transfer request can identify the terminated employee and the manager who is proposing the transfer. The receiving manager can review the terminated employee and if desired, assign the terminated employee to a position in the receiving manager's team. In one embodiment, the transfer request can specify a transfer from a first team to a second team while the approval can add in additional details like specifying a transfer from a position in a first team to a position in a second team.

In some embodiments, transfers recommendation engine 1450 can set a pending transfer flag on the account of the terminated employee to specify that the terminated employee is in the process of being transferred to another team. The pending transfer flag can be utilized during presentation of the organizational chart so that employees who are involved in a pending transfer can be identified using a visual cue such as a shaded tile or a tile with a dotted boundary. In some embodiments, the transfer request can be presented in the manager view as part of the transfer-in icon. Similarly, recommended actions which have been confirmed by the sending manager can be presented in the manager view as part of the transfer-out icon.

### Risk Analysis to Improve Workforce Planning

In some embodiments, operational workforce planning tool 130 can perform risk analysis during workforce planning. The risk analysis can assist in the workforce planning by estimating the natural attrition (e.g., employees leaving on their own accord) within a group or team of the organization. Predicting the natural attrition can be useful to manager 110. For example, manager 110 may need to reduce the headcount in a group due to budget or headcount cuts. If manager 110 has a prediction on the natural attrition, manager 110 may not need to terminate any team members since natural attrition may automatically reduce the size of the team. As another example, risk analysis can identify a number of team members within the team that are likely to leave the organization and determine that there is a job responsibility that is shared amongst one or more of the team members. If all the team members were to leave the organization, there would be a shortage of people within the team to perform the job responsibility. As a result, the risk analysis can recommend that manager 110 hire extra team members who can handle the job responsibility.

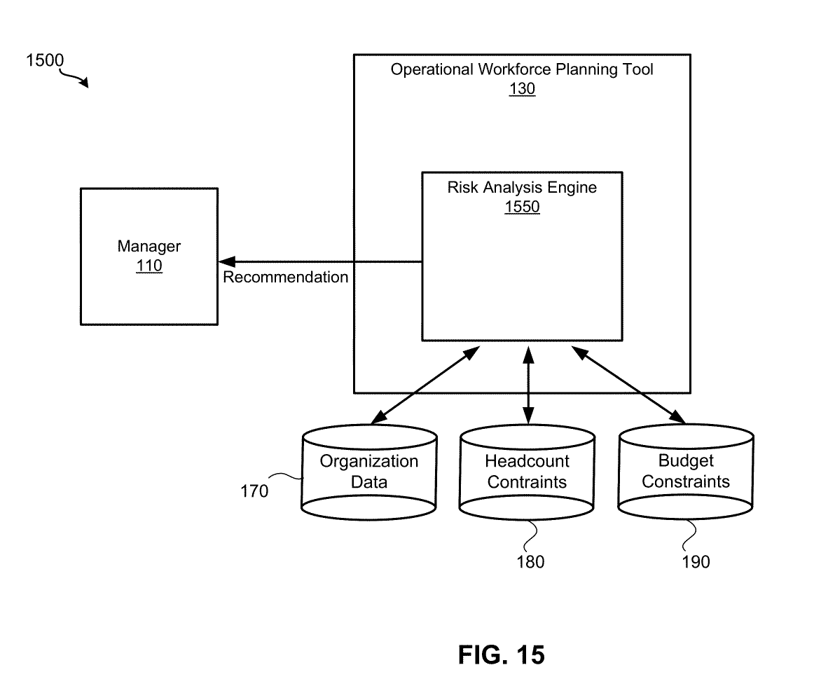

FIG. 15 illustrates a system for analyzing risk according to one embodiment. System 1500 includes manager 110, operational workforce planning tool 130, organization data 170, headcount constraints 180, and budget constraints 190. Operational workforce planning tool 130 can include risk analysis engine 1550. Risk analysis engine 1550 is configured to provide analysis based on the likelihood of natural attrition of team members within a team. Each team member can include a predicted voluntary termination rate that is stored within organization data 170. The predicted voluntary termination rate can predict the likelihood that the corresponding team member will leave the organization within a predetermined period of time, such as the next year.

Generation of the predicted voluntary termination rate can be performed on demand or alternatively can be generated on a predefined interval (such as quarterly or annually). In one embodiment, risk analysis engine 1550 (or a separate analytics product) can generate the predicted voluntary termination rate for a team member by searching an employee database for employees who are similar to the team member. The employee database can contain employees that are currently employed and employees that have left voluntarily within a predefined period of time (e.g., one year). The employee database can store attributes (i.e., dimensions) of each employee. Attributes can include tenure, age, job role, location, whether the employee voluntarily left, etc. Risk analysis engine 1550 can search employee database for employees that match the team member across one or more selected dimensions. The more dimensions that an employee matches the team member, the more similar the employee is to the team member. Risk analysis engine 1550 can adjust the number of employees returned by adjusting the number of selected dimensions. With every dimension added into the analysis, fewer employees can be found. Similarly with every dimension removed from the analysis, more employees can be found.

In one embodiment, risk analysis engine 1550 can automatically adjust the number of dimensions selected so that the number of employees returned is above or below a predefined threshold. For example, risk analysis engine 1550 can select additional dimensions until the number of employees returned is below a predefined threshold (e.g., return no more than 50 employees). As another example, risk analysis engine 1550 can start by selecting all the dimensions and unselect dimensions until the number of employees returned is above a predefined threshold (e.g., return at least 5 employees). In some examples, the available dimensions can be ranked in a predefined order so that risk analysis engine 1550 can automatically add or remove dimensions until the desired number of employees is returned. In other examples, dimensions which are discovered to have a low correlation with the employees can be removed. The returned employees are part of the sample pool.

Once the number of employees are returned, risk analysis engine 1550 can compare the employees in the sample pool. Employees who left voluntarily can be compared against those who are still employed by the organization. Analysis can be performed and a predicted voluntary termination rate can be generated. In one example, the predicted voluntary termination rate can be calculated by dividing the number of employees in the sample pool who voluntarily left by the total number of employees in the sample pool. In some embodiments, risk analysis engine 1550 can generate a confidence score on the predicted voluntary termination rate. The confidence score can be based on factors such as the sample size, historical variance (whether the environment has been stable recently. Events such as a financial crisis can skew results), and the number of dimensions selected to conduct the search.

Risk analysis engine 1550 can analyze the predicted voluntary termination rate of each team member within the team to provide recommendations to manager 110. In one embodiment, the recommendation can be to hire additional team members for a job responsibility when it is likely that the team will have a shortage of team members capable of performing the job responsibility. Risk analysis engine 1550 can analyze the team to determine a role within the team that is likely to be under represented due to natural attrition. For example, risk analysis engine 1550 can identify a plurality of team members having a predicted voluntary termination rate above a predefined threshold. Analysis of the plurality of team members can identify a job role or responsibility which is shared amongst many of the team members. As a result, risk analysis engine 1550 can generate a notification to manager 110 to recommend hiring one or more additional team members capable of performing the job role or responsibility. As another example, risk analysis engine 1550 can perform holistic analysis on the predicted voluntary termination rates of the team to identify a job role or job responsibility likely to see a reduction in the number of available team members. For instance, the holistic analysis can determine that five team members who are assigned to the same job role each have a 20% chance of voluntarily quitting their job by the end of the year. Thus, it is likely that one of the five will quit the job by the end of the year. As a result, risk analysis engine 1550 can recommend hiring an additional team member to perform the job role so that there will not be a reduction of team members capable of performing the job role.

In another embodiment, the recommendation can be to ignore headcount or budget constraints due to the predicted natural attrition. If team member are likely to leave the team on their own accord, managers may not need to make difficult decisions such as which team member to terminate when headcount or budget constraints dictate that cuts are necessary. Risk analysis engine 1550 can first determine whether headcount or budget constraints indicate that cuts are to be made to one or more teams managed by the manager. If cuts are to be made, risk analysis engine 1550 can retrieve the predicted voluntary termination rate of team members from organization data 170 and analyze the data. In one embodiment, the analysis can identify a job role that will likely experience a reduction in team members able to perform the job role. In another embodiment, the analysis can identify a team that will likely experience a reduction in head count. Based on the analysis, risk analysis engine 1550 can transmit a recommendation to the manager. The recommendation can be received as a notification which informs the manager that natural attrition may account for some or all of the reductions in headcount. Advantages of the recommendation include reducing the number of employees that cycle in and out of the organization, thus reducing overhead costs such as onboarding and unemployment benefits.

### Method Process Flows

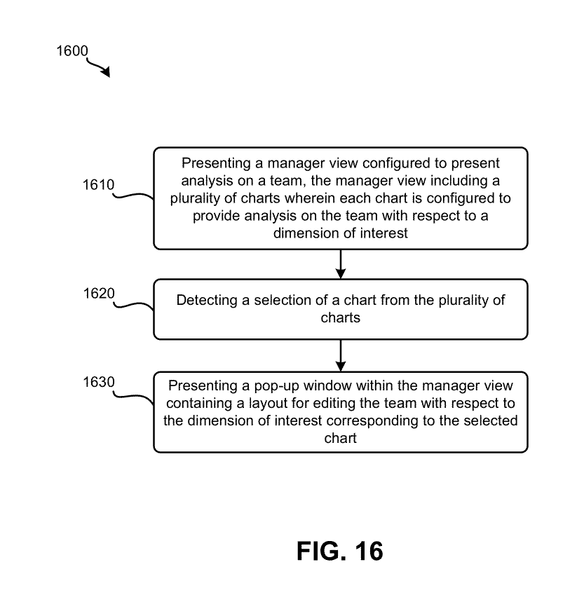

FIG. 16 illustrates a process for generating a manager view according to one embodiment. Process 1600 can be stored in computer readable code and executed by a processor. For example, process 1600 can be part of the computer readable code that makes up operational workforce planning tool 130 of FIG. 1. Process 1600 begins by presenting a manager view configured to present analysis on the team at step 1610. The manager view can include a plurality of charts wherein each chart is configured to provide analysis on the team with respect to a dimension of interest. Each chart can present analysis on underlying data that is associated with the team. The analysis can be presented using data markers within the chart. Examples of data markers include dots, lines, bars, etc. An exemplary manager view is shown in FIG. 4. Exemplary dimensions of interest include the available budget for a team, a headcount of the team, a headcount of the team grouped by geographical location, and/or a headcount of the team based on department. In some examples, a warning can be presented alongside a data marker when the underlying data corresponding to the data marker violates a predefined rule. For instance, a predefined rule can be configured to analyze the attrition rate of a department over time. If the attrition rate for a department is over a predefined threshold, a warning can be generated and presented alongside the chart.

After presenting the manager view, process 1600 can continue by detecting the selection of a chart from the plurality of charts that make up the manager view at 1620. Selection of a chart can include selecting the chart in its entirety or selecting a data marker within the chart. In response to the detection, process 1600 can continue by presenting a pop-up window within the manager view at 1630. The pop-up window can contain a layout for editing the team with respect to the dimension of interest that corresponds with the selected chart. In one embodiment, the layout can include a new entry to add a new team member to the team. One or more fields of the new entry can be automatically populated. In one embodiment, the auto population of fields can be based on the dimension of interest that corresponds with the selected chart. In instances where a data marker is selected within the chart, the auto population of fields can be based on the underlying data of the selected data marker. For example if the data marker is associated with the product department, then department field of the new entry can be automatically set to the product department. An example of an updated manager view that includes the pop-up window is shown in FIG. 6.

The manager view can also include a pull down menu containing a list of direct reports of the manager. In one embodiment, process 1600 can retrieve one or more planning tasks that have been generated by the direct report and present the one or more planning tasks in the manager view when it is detected that a direct report has been selected from the pull down menu. This allows the manager to review the planning tasks generated by the direct report and approve the planning tasks, when desirable. In another embodiment, process 1600 can retrieve a manager view that corresponds with a selected direct report. The manager view of the direct report can be presented along with the manager view of the manager. Alternatively, the manager view of the direct report can replace the manager view of the manager. This also allows the manager to review the workforce planning performed by the direct report. In some examples, the manager can interact with manager view of the direct report to make changes to the planning tasks generated by the direct report.

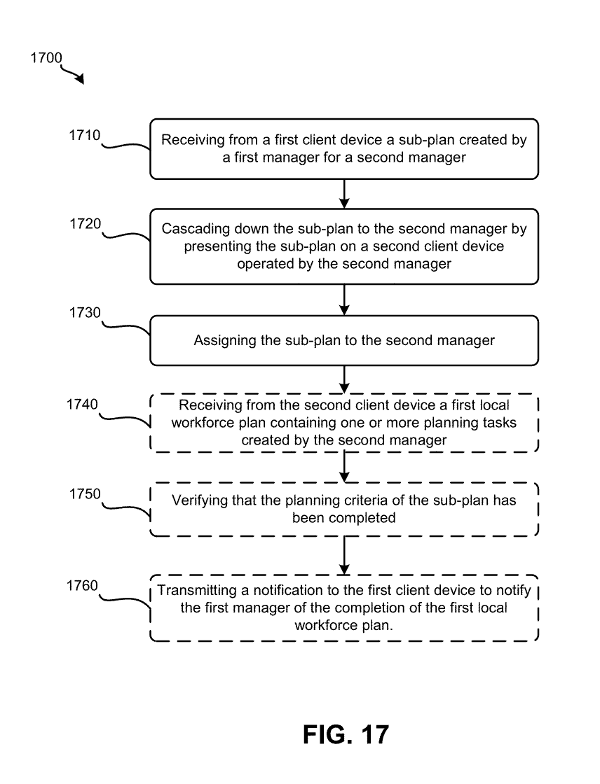

FIG. 17 illustrates a process for cascading a sub-plan for an upper level manager to a lower level manager according to one embodiment. Process 1700 can be stored in computer readable code and executed by a processor. For example, process 1700 can be part of the computer readable code that makes up operational workforce planning tool 130 of FIG. 1. Process 1700 can begin by receiving, from a first client device that is operated by an upper level manager, a sub-plan created by the upper level manager for a lower level manager at step 1710. The sub-plan can include one or more planning criteria. The planning criteria can specify a task, goal, or instruction generated by the upper level manager. In some examples, the planning criteria can originally be the responsibility of the upper level manager. For instance, the upper level manager may have a criteria to expand a division of the organization by 100 employees. Of the 100 employees, the upper level manager may wish to expand a department within the division by 50 employees. The upper level manager can create a sub-plan with a planning criteria to expand the department by 50 employees and send the sub-plan to the lower level manager that is managing the department. In essence, the upper level manager has delegated a portion of his responsibility (e.g., to expand the division by 100 employees) to a lower level manager.

Once the sub-plan is generated, process 1700 can cascade down the sub-plan to the lower level manager by presenting the sub-plan on a second client device operated by the lower level manager at 1720. The sub-plan can be transmitted to the second client device for presentation on a display of the second client device. In one example, the sub-plan can be presented as a notification in a lower level manager view on the second client device. The lower level manager view can contain a plurality of charts that analyze dimensions of a team managed by the lower level manager. Upon detecting the selection of the notification, operational workforce planning tool 130 can update the lower level manager view to include one or more charts for analyzing a planned criteria of the sub-plan. At 1730, the sub-plan can be assigned to the lower level manager. Assigning a sub-plan can include assigning planning criteria of the sub-plan to the lower level manager. As a result, the lower level manager will be expected to complete the sub-plan along with the lower level manager's own planning criteria during workforce planning.

When the lower level manager completes workforce planning, the local workforce plan generated by the lower level manager can be transmitted to operational workforce planning tool 130. Process 1700 can continue with operational workforce planning tool 130 optionally receiving from the second client device a local workforce plan containing one or more planning tasks created by the second manager at 1740. Once the local workforce plan is received, operational workforce planning tool 130 can verify that the planning criteria of the sub-plan (and optionally other planning criteria assigned to the lower level manager) have been completed at 1750. Process flow 1700 can then continue by transmitting a notification to the first client device to notify the first manager of the completion of the local workforce plan at 1760. The notification can be presented on an upper level manager view. Selection of the notification can result in the presentation of the local workforce plan for review. Alternatively, selection of the notification can result in the local workforce plan being applied to a workforce plan of the upper level manager, thus updating the workforce plan of the upper level manager.

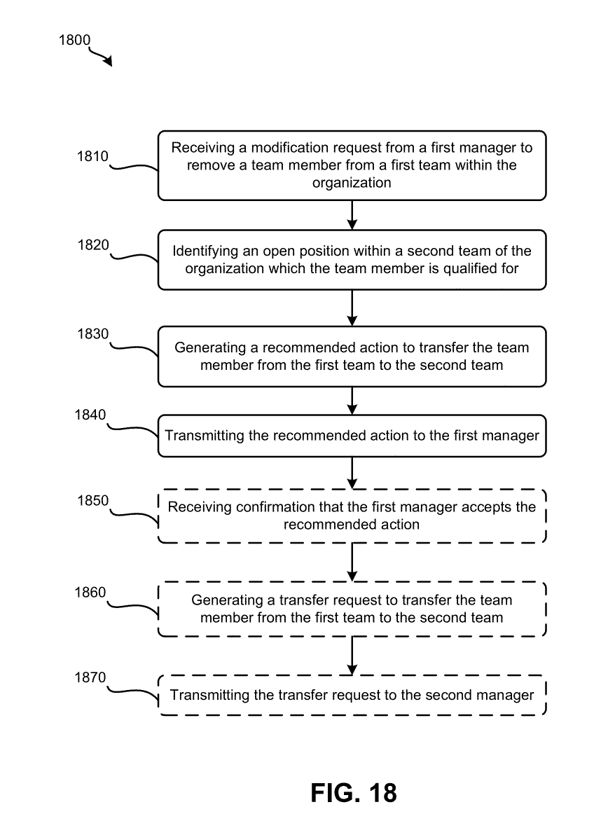

FIG. 18 illustrates a process for transferring employees between managers according to one embodiment. Process 1800 can be stored in computer readable code and executed by a processor. For example, process 1800 can be part of the computer readable code that makes up operational workforce planning tool 130 of FIG. 1. Process 1800 can begin by receiving a modification request from a first manager to remove a team member from a first team within the organization at 1810. The modification request can be received from a first client device operated by the first manager. Once the request is received, process 1800 can continue by identifying an open position within a second team of the organization which the team member is qualified for. The second team can be managed by a second manager. In one embodiment, identifying the open position can include querying a database of open positions within the organization to locate an open position which the team member is qualified for. Qualifying for an open position can be checked by matching an attribute of the team member with a requirement of the open position. Depending on the matching of attributes to requirements, process 1800 can determine that the team member is qualified for an open position. Once an open position is identified, process 1800 can generate a recommended action to transfer the team member from the first team to the second team at 1830. The recommended action can be transmitted to the first manager (via the first client device) at 1840.

In some scenarios, the first manager may agree with the recommended action and transmit a confirmation to operational workforce planning tool 130. At 1850, process 1800 can optionally receive confirmation that the first manager has accepted the recommended action. At 1860, process 1800 can generate a transfer request to transfer the team member to from the first team to the second team. The transfer request can then be transmitted to the second manager to see whether the second manager agrees to allow the team member to become a direct report of the second manager at 1870. In one embodiment, a pending transfer flag can be set on the team member when the confirmation is received from the first manager. The pending transfer flag can be utilized by operational workforce planning tool 130 to adjust the visual appearance of the team member in the organizational chart so that the first manager is aware that a transfer request can be sent out to transfer the team member to another team. The manager view of the second manager can also be adjusted so that the second manager is aware of the transfer request. In one embodiment, a transfer-in icon can be presented on the second client device when the transfer request is received by the second client device. Selection of the transfer-in icon can cause tiles that represent team members who are trying to be transferred into the team to appear. Each tile can represent a single team member. If the second manager repositions a tile to a location in the organizational chart presented in the manager view of the second manager, then the team member corresponding to the tile can be assigned to a position in the second team that corresponds with the location. A planning task can then be generated for the transfer. If the transfer is approved by upper level managers, then the transfer can be committed.

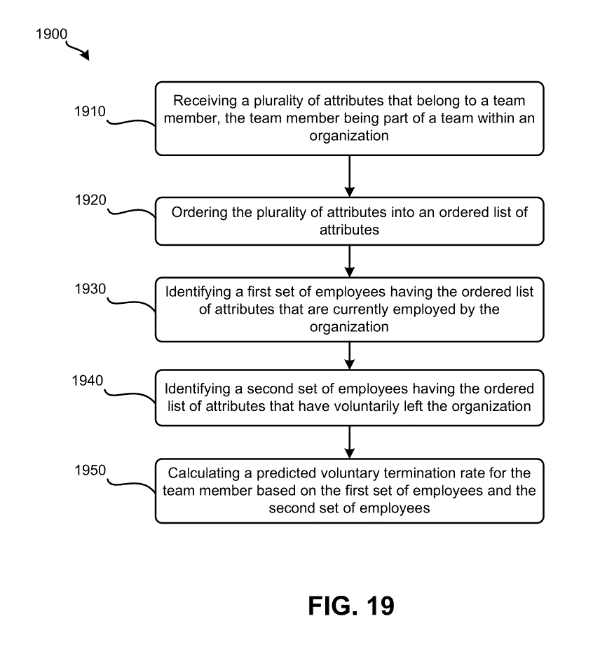

FIG. 19 illustrates a process for transferring employees between managers according to one embodiment. Process 1900 can be stored in computer readable code and executed by a processor. For example, process 1900 can be part of the computer readable code that makes up operational workforce planning tool 130 of FIG. 1. Process 1900 can begin by receiving a plurality of attributes that belong to a team member at 1910. The team member can be part of a team within an organization. The plurality of attributes can be a subset of the available attributes. Once the attributes are received, process 1900 can order the plurality of attributes into an ordered list of attributes at 1920. Attributes that are more relevant can be positioned in front of attributes that are less relevant. The relevancy of an attribute can depend on the ability of the attribute to affect the number of employees that are returned from a search in an employee database. The higher the effect of an attribute on the number of employees returned, the more relevant the attribute. For example, an age attribute may not affect the number of employees that have voluntarily left. However, a position attribute may affect the number of employees that have voluntarily left. For instance, employees may leave one position more often than other positions. As a result, the position attribute can be positioned higher than the age attribute in the ordered list.

After ordering the attributes into an ordered list, process 1900 can identify a first set of employees having the ordered list of attributes that are currently employed by the organization at 1930. In one embodiment, operational workforce planning tool 130 can search the employee database for currently employed employees who have the same set of attributes. At 1940, process 1900 can identify a second set of employees having the ordered list of attributes that have voluntarily left the organization. In one embodiment, operational workforce planning tool 130 can search the employee database for departed employees who have the same set of attributes. Once the first and second set of employees have been identified, process 1900 can continue by calculating a predicted voluntary termination rate for the team member based on the first and second set of employees at 1950. The predicted voluntary termination rate can be calculated by generating a total count for the first set of employees and the second set of employees as a combined set of employees and dividing the count of the second set of employees by the total count.

In some examples, the sample pool consisting of the first set of employees and the second set of employees can be below a predefined threshold. In these scenarios, process 1900 can optionally update the ordered list of attributes by removing one or more attributes. Attributes removed can be attributes which are not very relevant to the search. After attributes are removed from the ordered list of attributes, process 1900 can expand the first and second set of employees by searching the employee database a second time. This process can be repeated until the number of employees returned (i.e., the sample pool) is the desired size, which can be predefined. In one embodiment, attributes that are found to have a low correlation with the second set of employees can be automatically removed from the ordered list of attributes to simplify the search parameters. In another embodiment, each predicted voluntary termination rate can be accompanied by a calculated confidence index which states how confident the system is with respect to the predicted voluntary termination rate. The confidence index can be based on various factors, including the size of the sample pool, the ordered list of dimensions, or historical variance of the predicted voluntary termination rate.

Once the predicted voluntary termination rates have been calculated for each team member, risk analysis can be performed on the team. Risk analysis can identify team members from the team that have a predicted voluntary termination rate above a predefined threshold. This can be useful for various analysis. In one embodiment, similarities that exist between the team members can be identified. For example, a job responsibility that is shared amongst the team members can be identified and reported back to the manager. This allows the manager to proactively hire additional team members to offset the natural attrition. In another embodiment, risk analysis can help a manager during downsizing by notifying the manager of potential natural attrition so that the manager can reduce the number of employees that need to be terminated.

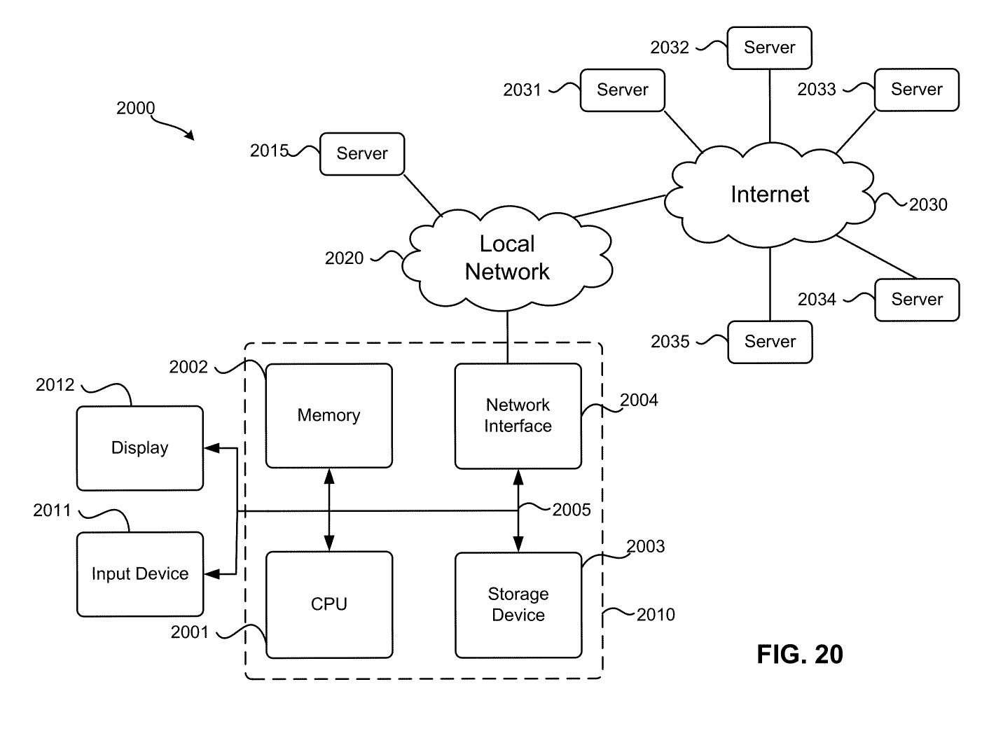

An exemplary computer system 2000 is illustrated in FIG. 20. Computer system 2010 includes a bus 2005 or other communication mechanism for communicating information, and a processor 2001 coupled with bus 2005 for processing information. Computer system 2010 also includes memory 2002 coupled to bus 2005 for storing information and instructions to be executed by processor 2001, including information and instructions for performing the techniques described above, for example. This memory may also be used for storing variables or other intermediate information during execution of instructions to be executed by processor 2001. Possible implementations of this memory may be, but are not limited to, random access memory (RAM), read only memory (ROM), or both. A storage device 2003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2003 may include source code, binary code, or software files for performing the techniques above, for example. Storage device and memory are both examples of computer readable mediums.

Computer system 2010 may be coupled via bus 2005 to a display 2012, such as a cathode ray tube (CRT) or liquid crystal display (LCD), for displaying information to a computer user. An input device 2011 such as a keyboard and/or mouse is coupled to bus 2005 for communicating information and command selections from the user to processor 2001. The combination of these components allows the user to communicate with the system. In some systems, bus 2005 may be divided into multiple specialized buses.

Computer system 2010 also includes a network interface 2004 coupled with bus 2005. Network interface 2004 may provide two-way data communication between computer system 2010 and the local network 2020. The network interface 2004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 2010 can send and receive information, including messages or other interface actions, through the network interface 2004 across a local network 2020, an Intranet, or the Internet 2030. For a local network, computer system 2010 may communicate with a plurality of other computer machines, such as server 2015. Accordingly, computer system 2010 and server computer systems represented by server 2015 may form a cloud computing network, which may be programmed with processes described herein. In the Internet example, software components or services may reside on multiple different computer systems 2010 or servers 2031-2035 across the network. The processes described above may be implemented on one or more servers, for example. A server 2031 may transmit actions or messages from one component, through Internet 2030, local network 2020, and network interface 2004 to a component on computer system 2010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a plurality of attributes that belong to a team member, the team member being part of a team within an organization;
ordering, by the processor, the plurality of attributes into an ordered list of attributes;
identifying, by the processor, a first set of employees having the ordered list of attributes that are currently employed by the organization;
identifying, by the processor, a second set of employees having the ordered list of attributes that have voluntarily left the organization; and
calculating, by the processor, a predicted voluntary termination rate for the team member based on the first set of employees and the second set of employees.

2. The computer-implemented method of claim 1, wherein calculating the predicted voluntary termination rate comprises:
calculating, by the processor, a total count consisting of the first set of employees and the second set of employees; and
dividing, by the processor, a count for the second set of employees by the total count to form the predicted voluntary termination rate.

3. The computer-implemented method of claim 1, wherein calculating the predicted voluntary termination rate comprises:
determining, by the processor, that a sample pool consisting of the first set of employees and the second set of employees is below a predefined threshold;
updating, by the processor, the ordered list of attributes by removing an attribute; and
expanding, by the processor, the first list of employees and the second list of employees based on the updated ordered list of attributes.

4. The computer-implemented method of claim 1, further comprising:
determining, by the processor, that an attribute from the ordered list of attributes has a low correlation with the second set of employees; and
updating, by the processor, the ordered list of attributes by removing the attribute.

5. The computer-implemented method of claim 1, further comprising:
determining, by the processor, that a plurality of team members from the team have the predicted voluntary termination rate above a predefined threshold;
identifying, by the processor, a job responsibility shared by at least two of the plurality of team members; and
generating, by the processor, a notification to hire another team member for the job responsibility.

6. The computer-implemented method of claim 1, further comprising:
determining, by the processor, that the size of the team is larger than a headcount budget of the team;
determining, by the processor, that a plurality of team members from the team have the predicted voluntary termination rate above a predefined threshold; and
generating, by the processor, a notification to report a natural attrition for the team.

7. The computer-implemented method of claim 1, further comprising:
calculating, by the processor, a confidence index corresponding to the predicted voluntary termination rate, the confidence index being derived from at least one factor including, size of sample pool, the ordered list of dimensions, or historical variance of the predicted voluntary termination rate.

8. A non-transitory computer readable storage medium storing one or more programs, the one or more programs comprising instructions for:
receiving a plurality of attributes that belong to a team member, the team member being part of a team within an organization;
ordering the plurality of attributes into an ordered list of attributes;
identifying a first set of employees having the ordered list of attributes that are currently employed by the organization;
identifying a second set of employees having the ordered list of attributes that have voluntarily left the organization; and
calculating a predicted voluntary termination rate for the team member based on the first set of employees and the second set of employees.

9. The non-transitory computer readable storage medium of claim 8, wherein calculating the predicted voluntary termination rate comprises:
calculating a total count consisting of the first set of employees and the second set of employees; and
dividing a count for the second set of employees by the total count to form the predicted voluntary termination rate.

10. The non-transitory computer readable storage medium of claim 8, wherein calculating the predicted voluntary termination rate comprises:
determining that a sample pool consisting of the first set of employees and the second set of employees is below a predefined threshold;
updating the ordered list of attributes by removing an attribute; and
expanding the first list of employees and the second list of employees based on the updated ordered list of attributes.

11. The non-transitory computer readable storage medium of claim 8, further comprising:
determining that an attribute from the ordered list of attributes has a low correlation with the second set of employees; and
updating the ordered list of attributes by removing the attribute.

12. The non-transitory computer readable storage medium of claim 8, further comprising:
determining that a plurality of team members from the team have the predicted voluntary termination rate above a predefined threshold;
identifying a job responsibility shared by at least two of the plurality of team members; and
generating a notification to hire another team member for the job responsibility.

13. The non-transitory computer readable storage medium of claim 8, further comprising:
determining that the size of the team is larger than a headcount budget of the team;
determining that a plurality of team members from the team have the predicted voluntary termination rate above a predefined threshold; and
generating a notification to report a natural attrition for the team.

14. The non-transitory computer readable storage medium of claim 8, further comprising:
calculating a confidence index corresponding to the predicted voluntary termination rate, the confidence index being derived from at least one factor including, size of sample pool, the ordered list of dimensions, or historical variance of the predicted voluntary termination rate.

15. A computer implemented system, comprising:
one or more computer processors; and
a non-transitory computer-readable storage medium comprising instructions, that when executed, control the one or more computer processors to be configured for:
receiving a plurality of attributes that belong to a team member, the team member being part of a team within an organization;
ordering the plurality of attributes into an ordered list of attributes;
identifying a first set of employees having the ordered list of attributes that are currently employed by the organization;
identifying a second set of employees having the ordered list of attributes that have voluntarily left the organization; and
calculating a predicted voluntary termination rate for the team member based on the first set of employees and the second set of employees.

16. The computer implemented system of claim 15, wherein calculating the predicted voluntary termination rate comprises:
determining that a sample pool consisting of the first set of employees and the second set of employees is below a predefined threshold;
updating the ordered list of attributes by removing an attribute; and
expanding the first list of employees and the second list of employees based on the updated ordered list of attributes.

17. The computer implemented system of claim 15, further comprising:
determining that an attribute from the ordered list of attributes has a low correlation with the second set of employees; and
updating the ordered list of attributes by removing the attribute.

18. The computer implemented system of claim 15, further comprising:
determining that a plurality of team members from the team have the predicted voluntary termination rate above a predefined threshold;
identifying a job responsibility shared by at least two of the plurality of team members; and
generating a notification to hire another team member for the job responsibility.

19. The computer implemented system of claim 15, further comprising:
determining that the size of the team is larger than a headcount budget of the team;
determining that a plurality of team members from the team have the predicted voluntary termination rate above a predefined threshold; and
generating a notification to report a natural attrition for the team.

20. The computer implemented system of claim 15, further comprising:
calculating a confidence index corresponding to the predicted voluntary termination rate, the confidence index being derived from at least one factor including, size of sample pool, the ordered list of dimensions, or historical variance of the predicted voluntary termination rate.
